(19) United States
(12) Patent Application Publication
(10) Pub. No.: US 2026/0184635 A1
(43) Pub. Date: Jul. 2, 2026

(54) SILVER CONTAINING CROSSLINKED POLYMERS AS ADMIXTURE IN CEMENTITIOUS COMPOSITIONS

(71) Applicants: UNIVERSITEIT GENT, Gent (BE); KATHOLIEKE UNIVERSITEIT LEUVEN, Leuven (BE)

(72) Inventors: Mohammadali YAZDI, Merelbeke (BE); Kim VAN TITTELBOOM, Zwijnaarde (BE); Nele DE BELIE, Zwijnaarde (BE); Sandra VAN VLIERBERGHE, Gent (BE); Georgios MISIAKOS, Gent (BE); Elke GRUYAERT, Gent (BE)

(73) Assignees: UNIVERSITEIT GENT, Gent (BE); KATHOLIEKE UNIVERSITEIT LEUVEN, Leuven (BE)

(21) Appl. No.: 19/128,702

(22) PCT Filed: Nov. 24, 2023
(86) PCT No.: PCT/EP2023/082967

§ 371 Date: May 9, 2025

(30) Foreign Application Priority Data
Nov. 25, 2022 (EP) 22386085.9

(51) Int. Cl. C04B 24/40; C04B 28/04; C04B 28/24; C04B 28/36; C04B 103/00; C08J 3/20; C08J 3/24; C08K 3/28; C08K 5/092

(52) U.S. Cl. CPC C04B 24/405; C04B 28/04; C04B 28/24; C04B 28/36; C08J 3/20; C08J 3/24; C08K 3/28; C08K 5/092; C04B 2103/0049; C04B 2103/0062; C08J 2305/04

(57) ABSTRACT

The present invention relates to a cementitious composition comprising one or more cementitious material(s); and a silver-containing, crosslinked polymer, wherein the crosslinked polymer is a covalently crosslinked polymer, and preferably wherein said silver-containing, crosslinked polymer comprises -A^{⊖} Ag^{⊕} groups; wherein A^{⊖} is an anion, preferably a carboxylate anion or a sulphonate anion. The present invention further relates to a silver-containing covalently crosslinked polymer, as comprised in said cementitious composition, and various uses of such compositions and polymers for preparing concrete materials with improved properties or for coating concrete structures.

### TECHNICAL FIELD

The present invention in general relates to the field of cementitious compositions and polymers contained therein. In particular, the invention relates to specific polymers for use as admixtures or as additives for cementitious compositions. The invention provides polymers, cementitious compositions, admixtures, and methods to prepare concrete structures having improved properties, and to protect concrete structures from damage caused by chloride ions.

### BACKGROUND

Cementitious structures, such as hardened/cured concrete or hardened/cured mortar, are prone to degradation and damages over time by elements of the environment. Shrinkage and chloride diffusion into the structure may result in crack formation, after which the degradation process may even speed up more, as chloride ions and other harmful substances can penetrate deeper into the structure through these cracks. When the chloride ions reach the steel rebars or reinforcements inside the cementitious structure, corrosion of the steel rebars occurs, which detrimentally impacts the durability of the cementitious structure. Therefore, there is a need for producing durable cementitious structures, especially, resistant to chloride diffusion and/or with limited shrinkage.

Repair techniques of damaged cementitious structures exist, however most of these repairs are unsatisfactory after a couple of years. For patch repairs, crack formation in the repair mortar or debonding of the repair mortar with the cementitious structure seems to be the most important shortcoming with the existing repair mortars. On top of that, many of the existing repair mortars are not suitable for stopping or reducing corrosion of the steel rebars. Hence, there is also a need in the art for repair mortars which are less prone to cracking and/or shrinking and have improved resistance to chloride ion diffusion and/or chloride ion ingress into the mortar or concrete.

Superabsorbent polymers (herein also denoted as “SAP”) have been used as additives or admixtures in cementitious compositions. However, one of the major downsides of using such superabsorbent polymers in cementitious compositions is that when preparing a workable cementitious composition, for example to add water to the cementitious composition to pour the cementitious compositions into a mould to make a cementitious structure, the superabsorbent polymers swell up to a voluminous particle, which will be embedded into the cementitious structure after hardening/curing. Eventually, voluminous superabsorbent polymer particles in the structure may dry out, leaving substantial voids or pores in the hardened cementitious structure. These voids and pores are not desired as they weaken the mechanical integrity of the hardened cementitious structure significantly.

In view of the above, there remains a continuous need in the art to further improve cementitious compositions and repair techniques for repairing concrete structures.

It is therefore an object of the present invention to provide improved polymers, compositions, admixtures, and processes which allow to fulfil at least some of the above indicated needs or which overcome at least some of the above indicated shortcomings.

### SUMMARY OF THE INVENTION

It has now surprisingly been found that some or all of the above demands and objectives can be attained either individually or in any combination by a polymer and a composition as defined herein. In particular, the silver-containing, crosslinked polymers disclosed herein may bind and/or capture chloride ions, so that these chloride ions cannot penetrate into cementitious structures, and corrode steel rebar inside the cementitious structures.

To that end, the present invention thereto provides a cementitious composition, preferably a concrete composition or a repair mortar or a repair paste or a concrete coating composition, wherein said cementitious composition comprises
one or more cementitious material(s); preferably wherein said one or more cementitious material(s) is (are) selected from the group comprising cement, fly ash, ground granulated slag, limestone, latent hydraulic materials, pozzolanic materials, geopolymers and alkali activated materials, or any combination thereof; and,
a silver-containing, crosslinked polymer, wherein the crosslinked polymer is a covalently crosslinked polymer, and preferably wherein said silver-containing, crosslinked polymer comprises -A^{⊖} Ag^{⊕} groups; wherein A^{⊖} is an anion, preferably a carboxylate anion (—COO^{⊖}) or a sulphonate anion (—SO₃^{⊖}), and
optionally, an aggregate.

More particularly, the invention provides in a cementitious composition, preferably a concrete composition or a repair mortar or a repair paste or a concrete coating composition, wherein said cementitious composition comprises
one or more cementitious material(s); preferably wherein said one or more cementitious material(s) is (are) selected from the group comprising cement, fly ash, ground granulated slag, limestone, latent hydraulic materials, pozzolanic materials, geopolymers and alkali activated materials, or any combination thereof; and,
a silver-containing, crosslinked polymer, wherein the crosslinked polymer is a covalently crosslinked polymer, and preferably wherein said silver-containing, crosslinked polymer comprises -A^{⊖} Ag^{⊕} groups; wherein A^{⊖} is an anion, preferably a carboxylate anion (—COO^{⊖}) or a sulphonate anion (—SO₃^{⊖}), and
optionally, an aggregate.

wherein the silver-containing, covalently crosslinked polymer comprises at least 2.0 weight % of silver ions, with wt % expressed as compared to the total weight of the (dry) silver-containing crosslinked polymer.

In certain embodiments of the present invention a cementitious composition is provided, wherein said crosslinked polymer is obtained by crosslinking polymer chains of a polymer that comprises vinyl groups and/or (meth)acrylate groups, preferably (meth)acrylate groups.

In certain embodiments of the present invention a cementitious composition is provided, wherein said crosslinked polymer is obtained by crosslinking polymer chains of a polymer in the presence of additional reactive monomer, preferably wherein said reactive monomer is selected from the group comprising (meth)acrylic acid, (meth)acrylamide, 2-(di(m)ethylamino)ethyl (meth)acrylate, N-[3-(dimethylamino) propyl]methacrylamide, and 2-Acrylamido-2-methyl-1-propanesulfonic acid; preferably wherein the reactive monomer is (meth)acrylic acid.

In certain embodiments of the present invention a cementitious composition is provided, wherein the polymer that is crosslinked is
(a) a polysaccharide or a salt derivative thereof, preferably a polysaccharide comprising sugar moieties wherein the sugar moieties comprise an acid functionality or a salt derivative thereof, preferably an alkali metal salt derivative thereof, more preferably an alginate or a salt derivative thereof, preferably an alkali metal salt derivative thereof; and/or
(b) wherein the polymer that is crosslinked is a synthetic polymer having anionic groups, preferably carboxylate anion (—COO^{⊖}) or a sulphonate anion (—SO₃^{⊖}) groups, and preferably is a poly(aspartic acid) or a salt derivative thereof, preferably an alkali metal salt derivative thereof.

In certain embodiments of the present invention a cementitious composition is provided, wherein the cementitious composition comprises at least 0.10 weight % to at most 5.00 weight %, with weight % (wt %) based on the total weight of the cementitious composition, of said silver-containing, covalently crosslinked polymer.

In certain embodiments of the present invention a cementitious composition is provided, wherein the silver-containing, covalently crosslinked polymer comprises at least 2.0 weight % to at most 30.0 weight % of silver ions, with wt % expressed as compared to the total weight of the (dry) silver-containing crosslinked polymer.

In certain embodiments of the present invention a cementitious composition is provided, wherein the polymer that is crosslinked is a hydrophilic polymer; and/or, wherein the swelling capacity (g/g) of the crosslinked polymer without the silver ions is at least 10.0, measured as described in the specification, preferably in deionized water.

In another aspect, the present invention also provides a method for making a cementitious composition comprising the steps of:
a) preparing a cementitious composition by mixing one or more cementitious material(s), preferably as defined herein, and a silver-containing covalently crosslinked polymer, and preferably a silver-containing, crosslinked polymer as defined herein; and optionally aggregate(s), and,
b) optionally, further admixing said cementitious composition with a suitable amount of water, optionally comprising an alkali activator, thereby obtaining a workable and curable cementitious composition.

The present invention further relates to a silver-containing, crosslinked polymer,
wherein the crosslinked polymer is a covalently crosslinked polymer, and
wherein said crosslinked polymer comprises -A^{⊖} Ag^{⊕} groups; wherein A^{⊖} is an anion, preferably a carboxylate anion (—COO^{⊖}) or a sulphonate anion (—SO₃^{⊖}), and

preferably wherein the silver-containing crosslinked polymer is as defined herein.

In a preferred example, a silver-containing crosslinked polymer is defined and as used in the present invention is a silver carboxylate crosslinked polymer, wherein said crosslinked polymer comprises —COO^{⊖} Ag^{⊕} groups, and wherein said crosslinked polymer is obtained by crosslinking an alkali metal carboxylate polymer, having (meth)acrylate groups, optionally in the presence of additional (meth)acrylic acid, and wherein said alkali metal carboxylate polymer is selected from the group comprising alkali metal polysaccharides, preferably alkali metal alginate, more preferably sodium alginate.

The present invention further provides a method for preparing a silver-containing, crosslinked polymer, preferably a silver-containing, crosslinked polymer as defined herein, comprising the steps of:
a) providing a crosslinked polymer,
   wherein the crosslinked polymer comprises polymer chains, and wherein at least a part of said polymer chain is crosslinked to each other through covalent bonds; and
   wherein the crosslinked polymer comprises -A^{⊖}R^{⊕} groups, wherein A^{⊖} is an anion, preferably a carboxylate anion (—COO^{⊖}) or a sulphonate anion (—SO₃^{⊖}), and R^{⊕} is a cation, preferably a hydrogen or an alkali metal cation; and
b) contacting said crosslinked polymer with a silver ion (Ag^{⊕}) solution, thereby forming said silver-containing, crosslinked polymer comprising -A^{⊖}Ag^{⊕} groups.

In certain preferred embodiments of such method for preparing said polymer, the crosslinked polymer is obtained by
(i) crosslinking polymer chains of a polymer comprising said -A^{⊖}R^{⊕} groups, and further comprising vinyl groups and/or (meth)acrylate groups, and/or,
(ii) by crosslinking polymer chains of a polymer in the presence of additional reactive monomer, preferably wherein said reactive monomer is selected from the group comprising (meth)acrylic acid, (meth)acrylamide, 2-(di(m)ethylamino)ethyl (meth)acrylate, N-[3-(dimethylamino) propyl]methacrylamide, or 2-Acrylamido-2-methyl-1-propanesulfonic acid; preferably wherein the reactive monomer is (meth)acrylic acid.

The present invention further provides a method for preparing a concrete material having reduced shrinkage and/or showing reduced chloride ion diffusion and/or ingress, comprising the step of preparing said concrete material with a cementitious composition according to an embodiment disclosed herein.

Further contemplated by the present invention is a method for repairing damaged areas in a concrete structure, said method comprising the step of filling and/or treating said damaged areas with a cementitious composition as defined herein or as prepared as described herein.

The present invention further relates to the use of a silver-containing, covalently crosslinked polymer, preferably a silver-containing, crosslinked polymer as defined herein as an admixture in a cementitious composition, such as a concrete composition or a repair mortar or a repair paste or a concrete coating composition. Preferably such admixture is a shrinkage reducing agent and/or a chloride binding agent. Further uses are elaborated in the description below.

It has been found by the inventors that the silver in the silver-containing, covalently crosslinked polymer has the ability to form a precipitate with chloride ions, and can therefore protect the (hardened) cementitious composition from chloride diffusion or chloride ingress in general. Therefore, rebars or reinforcement inside said (hardened) cementitious composition may be protected from chloride-induced reinforcement corrosion.

It was also found that the presence of the silver in the silver-containing, covalently crosslinked polymer reduces the swelling capacity of the silver-containing, covalently crosslinked polymer compared to the same covalently crosslinked polymer without the silver. This has the advantage that upon preparation of workable cementitious composition (for example by adding water), the silver-containing, covalently crosslinked polymer swells up to rather small particles, leaving rather small voids in the hardened structure, thereby minimizing the impact on the mechanical integrity of the structure.

It has been found that the covalently crosslinked polymer may regain larger swelling capacities, after losing parts of the silver. Hence, while protecting the structure from chloride ions, parts of the silver will precipitate, leaving the covalently crosslinked polymer behind in the structure, which regains swelling capacities as the process goes on. Hence, self-sealing and self-healing properties of the structure increase, after been protected from chloride ions.

It has been found that the total shrinkage of a structure made from the cementitious compositions according to an embodiment of the invention is lower compared to structures made from a cementitious composition comprising SAP. Especially for repair mortars, a low total shrinkage is preferred as this results in a better seal and adhesion between the repair mortar and the repaired structure.

It has been found that the silver-containing, covalently crosslinked polymers according to an embodiment of the invention may be able to provide higher resistance to frost damage. This may be the result of the silver-containing, covalently crosslinked polymers creating macropores in the cementitious structure, which may permit to reduce the pressure of freezing water in macropores which may otherwise result in cracks.

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### DETAILED DESCRIPTION OF THE FIGURES

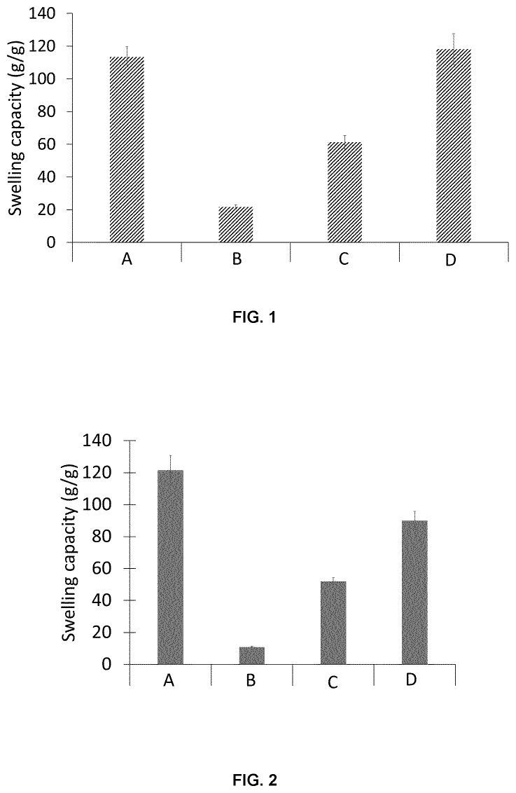

FIG. 1 illustrates the swelling capacity of polymers according to the invention (see example 1), and a comparative polymer (without silver), in the absence and in the presence of chloride ions, as explained in Example 4.

FIG. 2 illustrates the swelling capacity of polymers according to the invention (see example 2), and a comparative polymer (without silver), in the absence and in the presence of chloride ions, as explained in Example 5.

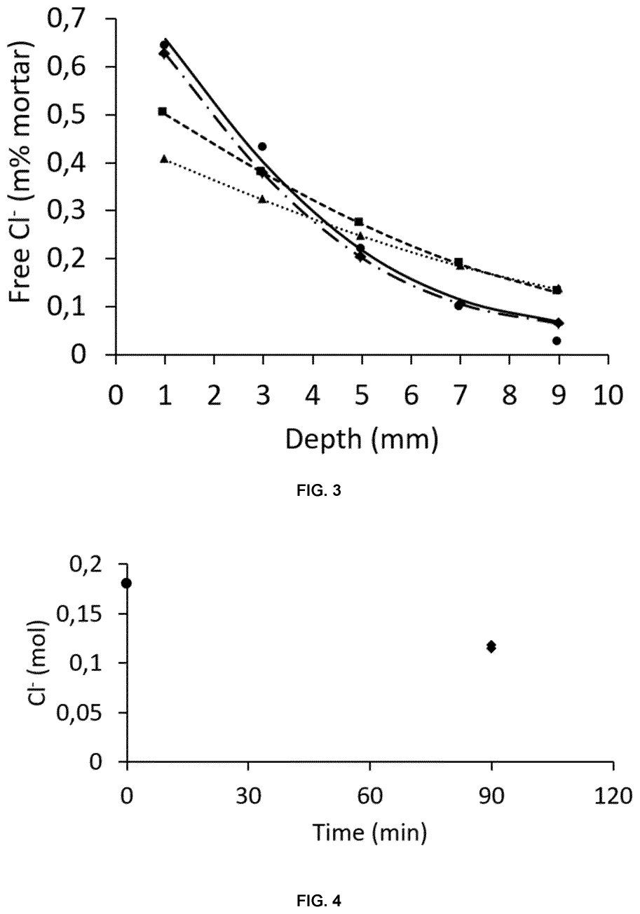

FIG. 3 illustrates the free CI-ions profiles in concrete samples for different depths from the exposure surface, as explained in Example 6.

FIG. 4 illustrates the concentration of CI ions in the extracted cement pore solution premixed with 1 wt % NaCl, as explained in Example 7.

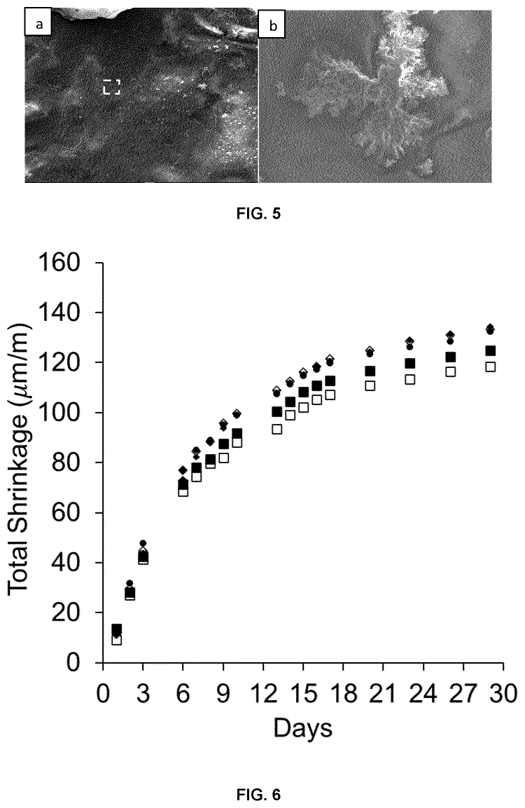

FIG. 5 illustrates the SEM-EDX images of the silver containing, covalently crosslinked polymers according to an embodiment of the invention, as explained in Example 7.

FIG. 6 illustrates the total shrinkage of mortar samples as explained in Example 8.

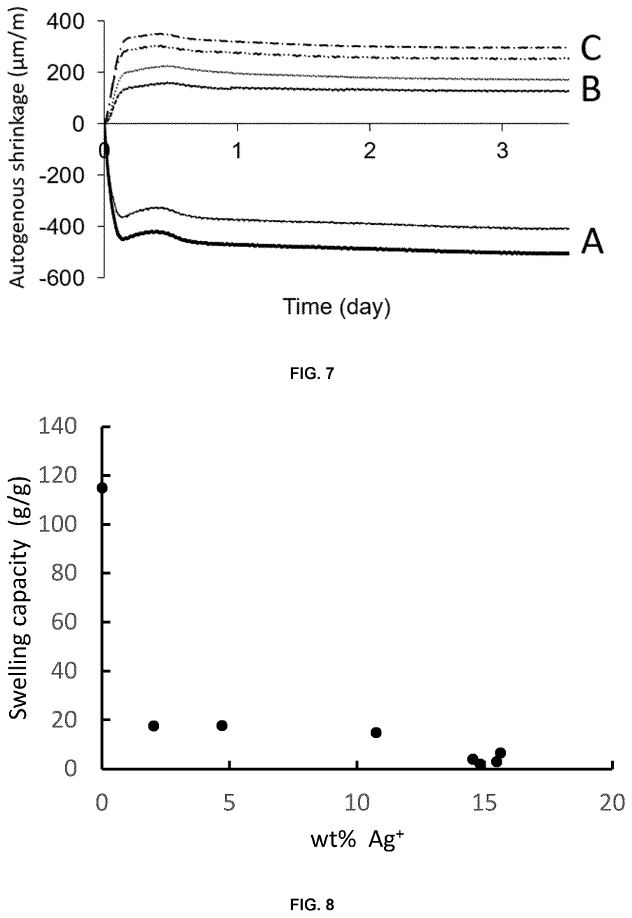

FIG. 7 illustrates the autogenous shrinkage of mortar samples as explained in Example 10.

FIG. 8 depicts the swelling capacity of the Cross-Alg-MA-Ag as prepared in Example 1.

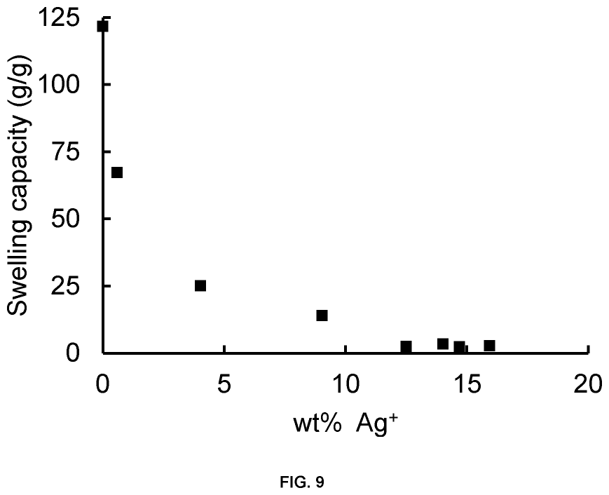

FIG. 9 depicts the swelling capacity of the Cross-PA-Alg-MA-Ag as prepared in Example 2.

### DETAILED DESCRIPTION OF THE INVENTION

When describing the invention, the terms used are to be construed in accordance with the following definitions, unless a context dictates otherwise.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

The terms “comprising”, “comprises” and “comprised of” as used herein are synonymous with “including”, “includes”, “containing” or “contains”, and are inclusive or open-ended and do not exclude additional, non-recited members, elements, or method steps. It will be appreciated that the terms “comprising”, “comprises” and “comprised of” as used herein comprise the terms “consisting of”, “consists” and “consists of”.

As used in the specification and the appended claims, the singular forms “a”, “an,” and “the” include plural referents unless the context clearly dictates otherwise. By way of example, “a step” means one step or more than one step.

Unless defined otherwise, all technical and scientific terms used herein have the same meaning as is commonly understood by one of skill in the art.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the end point values themselves (e.g. from 1.0 to 5.0 includes both 1.0 and 5.0). Any numerical range recited herein is intended to include all sub-ranges subsumed therein.

The term “about” as used herein when referring to a measurable value such as a parameter, an amount, a temporal duration, and the like, is meant to encompass variations of +/−10% or less, preferably +/−5% or less, more preferably +/−1% or less, of and from the specified value, insofar such variations are appropriate to perform in the disclosed invention. It is to be understood that the value to which the modifier “about” refers is itself also specifically, and preferably, disclosed.

The terms “wt %” or ‘weight %” are used herein as synonyms and refer to a weight percentage of a component, based on the total weight of material, which includes the component.

When describing the present invention, the terms used are to be construed in accordance with the following definitions, unless a context dictates otherwise.

Preferred statements (features) and embodiments and uses of this invention are set herein below. Each statement and embodiment of the invention so defined may be combined with any other statement and/or embodiment unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered statements and embodiments, with any other aspect and/or embodiment.
1. A cementitious composition, preferably wherein said composition is a concrete composition, a repair mortar, a repair paste, or a concrete coating composition, wherein said cementitious composition, comprises:
   one or more cementitious material(s); and,
   a silver-containing, crosslinked polymer, wherein the crosslinked polymer is a covalently crosslinked polymer, and,
   optionally, an aggregate.
2. A cementitious composition, preferably a concrete composition, a repair mortar, a repair paste, or a concrete coating composition, and wherein said cementitious composition comprises
   one or more cementitious material(s); preferably wherein said one or more cementitious material(s) is (are) selected from the group comprising cement, fly ash, ground granulated slag, limestone, latent hydraulic materials, pozzolanic materials, geopolymers and alkali activated materials, or any combination thereof; and,
   a silver-containing crosslinked polymer, wherein the crosslinked polymer is a covalently crosslinked polymer, and preferably wherein said silver-containing, crosslinked polymer comprises -A^{⊖}Ag^{⊕} groups; wherein A^{⊖} is an anion, preferably a carboxylate anion (—COO^{⊖}) or a sulphonate anion (—SO₃^{⊖}), and
   optionally, an aggregate;
wherein the silver-containing, covalently crosslinked polymer comprises at least 2.0 weight % of silver ions, with wt % expressed as compared to the total weight of the (dry) silver-containing crosslinked polymer.
3. The cementitious composition according to statement 1 or statement 2, wherein said cementitious composition is a workable and curable cementitious composition which further comprises water, and optionally an alkali activator.
3. The cementitious composition according to any one of the previous statements, wherein said silver-containing crosslinked polymer comprises polymer chains, and wherein at least a part of said polymer chains are crosslinked to each other through covalent bonds.
4. The cementitious composition according to any one of the previous statements, wherein said silver-containing crosslinked polymer comprises -A^{⊖}Ag^{⊕} groups; wherein A is an anion, preferably a carboxylate anion (—COO^{⊖}) or a sulphonate anion (—SO₃^{⊖}).
5. The cementitious composition according to any one of the previous statements, wherein said crosslinked polymer is obtained by crosslinking polymer chains of a polymer that comprises A^{⊖} R^{⊕} groups; wherein A^{⊖} is an anion, preferably a carboxylate anion (—COO^{⊖}) or a sulphonate anion (—SO₃^{⊖}), and wherein R^{⊕} is a cation, preferably a monovalent cation, preferably H⁺ or an alkali metal cation, preferably an alkali metal cation.
6. The cementitious composition according to any one of the previous statements, wherein said crosslinked polymer is obtained by crosslinking polymer chains of a polymer that comprises vinyl groups and/or (meth)acrylate groups, preferably (meth)acrylate groups.
7. The cementitious composition according to any one of the previous statements, wherein said crosslinked polymer is obtained by crosslinking polymer chains of a polymer in the presence of additional reactive monomer.
8. The cementitious composition according to statement 7, wherein the reactive monomer is a compound comprising a vinyl group or a —CH═CHMe group, preferably a vinyl group.
9. The cementitious composition according to statement 7, wherein the reactive monomer is a compound comprising a carboxyl group or a sulfonate group, preferably a carboxyl group.
10. The cementitious composition according to statement 7, wherein said reactive monomer is selected from the group comprising (meth)acrylic acid, (meth)acrylamide, 2-(di(m)ethylamino)ethyl (meth)acrylate, N-[3-(dimethylamino) propyl]methacrylamide, and 2-Acrylamido-2-methyl-1-propanesulfonic acid; preferably wherein the reactive monomer is (meth)acrylic acid.
11. The cementitious composition according to any one of the previous statements, wherein the polymer that is crosslinked is a hydrophilic polymer.
12. The cementitious composition according to any one of the previous statements, wherein the polymer that is crosslinked is a polyol, a polyamine or a polyacid, preferably a polyacid.
13. The cementitious composition according to any one of the previous statements, wherein the polymer that is crosslinked is a polysaccharide or a salt derivative thereof, preferably a polysaccharide comprising sugar moieties wherein the sugar moieties comprise an acid functionality or a salt derivative thereof, preferably an alkali metal salt derivative thereof, and more preferably an alginate or a salt derivative thereof, preferably an alkali metal salt derivative thereof.
14. The cementitious composition according to any one of the previous statements, wherein the polymer that is crosslinked is a synthetic polymer having anionic groups, preferably carboxylate anion (—COO^{⊖}) or sulphonate anion (—SO₃^{⊖}) groups, and more preferably is poly(aspartic acid) or a salt derivative thereof, preferably an alkali metal salt derivative thereof.
15. The cementitious composition according to any one of the previous statements, wherein the alkali metal is lithium, sodium or potassium, preferably sodium.
16. The cementitious composition according to any one of the previous statements, wherein the polymer that is crosslinked is an alkali metal carboxylate polymer that comprises (meth)acrylate groups, and preferably is a methacrylated sodium alginate.
17. The cementitious composition according to any one of the previous statements, wherein the silver-containing crosslinked polymer comprises at least 2.0 weight % of silver ions, or at least 5.0 weight % of silver ions, or at least 7.0 weight % of silver ions, or at least 10.0 weight % of silver ions, or at least 12.0 weight % silver ions, or at least 14.0 weight % of silver ions, with wt % expressed as compared to the total weight of the (dry) silver-containing, covalently crosslinked polymer.
18. The cementitious composition according to any one of the previous statements, wherein the silver-containing crosslinked polymer comprises at most 30.0 weight % of silver ions, or at most 25.0 weight % of silver ions, or at most 22.0 weight % of silver ions, or at most 20.0 weight % of silver ions, or at most 18.0 weight % of silver ions, or at most 16.0 weight % of silver ions, with wt % expressed as compared to the total weight of the (dry) silver-containing, covalently crosslinked polymer.
19. The cementitious composition according to any one of the previous statements, wherein the silver-containing crosslinked polymer comprises at least 2.0 weight % to at most 30.0 weight % of silver ions, or at least 5.0 weight % to at most 25.0 weight % of silver ions, or at least 7.0 weight % to at most 22.0 weight % of silver ions, or at least 10.0 weight % to at most 20.0 weight % of silver ions, or at least 12.0 weight % to at most 18.0 weight % of silver ions, or at least 14.0 weight % to at most 16.0 weight % of silver ions, with wt % expressed as compared to the total weight of the (dry) silver-containing, covalently crosslinked polymer.
20. The cementitious composition according to any one of the previous statements, wherein the crosslinked polymer is a superabsorbent polymer, or wherein the silver-containing crosslinked polymer is a silver-containing superabsorbent polymer.
21. The cementitious composition according to any one of the previous statements, wherein the swelling capacity (g/g) of the crosslinked polymer, measured as described in the specification, without the silver ions is at least 10.0, preferably at least 25.0, preferably at least 50.0, preferably at least 75.0, preferably at least 100.0, preferably at least 125.0, preferably at least 150.0, preferably in deionised water.
22. The cementitious composition according to any one of the previous statements, wherein the polymer (before crosslinking) has a Mw of at least 20,000 g/mol; such as a Mw of at least 20.000 g/mol to at most 750,000 g/mol, preferably at least 50,000 to at most 500,000 g/mol, preferably at least 100,000 to at most 250,000 g/mol.
23. The cementitious composition according to any one of the previous statements, wherein the polymer (before crosslinking) has a Mn of 15,000; such as a Mn of at least 15,000 g/mol to at most 70,000 g/mol, preferably at least 20,000 to at most 50,000 g/mol, preferably at least 30,000 to at most 40,000 g/mol.
24. The cementitious composition according to any one of the previous statements, wherein the polymer (before crosslinking) has at least 1.0, preferably at least 3.0, preferably at least 5.0, preferably at least 7.0, preferably at least 9.0 (meth)acryl substituents per 100 monomers, as determined by ¹H-NMR spectroscopy.
25. The cementitious composition according to any one of the previous statements, wherein the polymer (before crosslinking) has at least 1.0 to at most 25.0, preferably at least 3.0 to at most 20.0, preferably at least 5.0 to at most 18.0, preferably at least 7.0 to at most 16.0, preferably at least 9.0 to at most 15.0 (meth)acryl substituents per 100 monomers, as determined by ¹H-NMR spectroscopy.
26. The cementitious composition according to any one of the previous statements, wherein the polymer (that is crosslinked) comprises at least 0.2, preferably at least 0.4, preferably at least 0.5, preferably at least 0.6, preferably at least 0.8, preferably at least 1.0 carboxylate anion (—COO^{⊖}) or a sulphonate anion (—SO₃^{⊖}) per monomer.
27. The cementitious composition, preferably a concrete composition or a repair mortar, and preferably a cementitious composition according to any one of the previous statements, wherein said cementitious composition comprises:
   one or more cementitious material(s), preferably as defined herein; and,
   a silver-containing, crosslinked polymer, and
   optionally, an aggregate
wherein said silver-containing crosslinked polymer is a silver carboxylate crosslinked polymer,
wherein said crosslinked polymer comprises —COO^{⊖}Ag^{⊕} groups, and
wherein said crosslinked polymer is obtained by crosslinking an alkali metal carboxylate polymer, having (meth)acrylate groups,
optionally in the presence of additional (meth)acrylic acid,
and wherein said alkali metal carboxylate polymer is selected from the group comprising alkali metal polysaccharides, preferably alkali metal alginate, more preferably sodium alginate.
28. The cementitious composition according to any one of the previous statements, wherein the cementitious composition comprises at least 0.10 weight % to at most 5.00 weight %, preferably at least 0.20 weight % to at most 3.00 weight %, preferably at least 0.30 weight % to at most 2.00 weight %, preferably at least 0.40 weight % to at most 1.00 weight %, with wt % based on the total weight of the cementitious composition, of said silver-containing crosslinked polymer.
29. The cementitious composition according to any one of the previous statements, wherein said one or more cementitious material(s) is selected from the group comprising cement, fly ash, ground granulated slag, limestone, latent hydraulic materials, pozzolanic materials, alkali activated materials, and any combination thereof.
30. A method for making a cementitious composition comprising the steps of:
   a) preparing a cementitious composition by mixing one or more cementitious material(s), preferably as defined herein, a silver-containing covalently crosslinked polymer, and preferably a silver-containing crosslinked polymer as defined in any one of previous statements; and optionally aggregate, and,
   b) optionally, further admixing said cementitious composition with a suitable amount of water, thereby obtaining a workable and curable cementitious composition.
31. The method according to the previous statement, wherein the silver-containing covalently crosslinked polymer is pre-soaked in water, preferably wherein the silver-containing covalently crosslinked polymer is saturated with water.
32. A structure comprising a cementitious composition according to any one of previous statements, and preferably comprising a cementitious composition according to any one of previous statements that is cured.
33. A method for making a structure, such as a concrete structure, from a cementitious composition, the method comprising the steps of:
   a) preparing a cementitious composition according to any of the previous statements, or as defined in statements 29 or 30, and
   b) pouring said cementitious composition in a mould, wherein the mould optionally comprises steel rebars; or, printing said cementitious composition optionally mould free and optionally around steel rebars; and
   d) curing the cementitious composition for a suitable curing time, thereby allowing the cementitious composition to set and harden, thereby forming a structure, such as a concrete structure.
34. A silver-containing crosslinked polymer, wherein the crosslinked polymer is a covalently crosslinked polymer, and wherein said crosslinked polymer comprises -A^{⊖}Ag^{⊕} groups; wherein A^{⊖} is an anion, preferably a carboxylate anion (—COO^{⊖}) or a sulphonate anion (—SO₃^{⊖}).
35. A silver-containing crosslinked polymer,
   wherein said crosslinked polymer comprises polymer chains, and wherein at least a part of said polymer chains are crosslinked to each other through covalent bonds;
   wherein said crosslinked polymer comprises -A^{⊖}Ag^{⊕} groups; wherein A^{⊖} is an anion, preferably a carboxylate anion (—COO^{⊖}) or a sulphonate anion (—SO₃^{⊖}).
36. The silver-containing crosslinked polymer according to statement 34 or 35, wherein said silver-containing crosslinked polymer is as defined in any one of the previous statements 1 to 29.
37. A method for preparing a silver-containing crosslinked polymer, preferably a silver-containing, covalently crosslinked polymer according to any one of previous statements, comprising the steps of:
a) providing a crosslinked polymer,
   wherein the crosslinked polymer comprises polymer chains, and wherein at least a part of said polymer chain is crosslinked to each other through covalent bonds;
   wherein the crosslinked polymer comprises -A^{⊖}R^{⊕} groups, wherein A^{⊖} is an anion, preferably a carboxylate anion (—COO^{⊖}) or a sulphonate anion (—SO₃^{⊖}), and R^{⊕} is a cation, preferably a hydrogen or an alkali metal cation; and
b) contacting said crosslinked polymer with a silver ion (Ag^{⊕}) solution, thereby forming said silver-containing crosslinked polymer comprising -A^{⊖}Ag^{⊕} groups.
38. The method according to the previous statement 37, wherein said crosslinked polymer is obtained by crosslinking polymer chains of a polymer comprising said -A^{⊖}R^{⊕} groups.
39. The method according to any one of the previous statements 37 to 38, wherein said crosslinked polymer is obtained by crosslinking polymer chains of a polymer comprising said -A^{⊖}R^{⊕} groups and further having vinyl groups and/or (meth)acrylate groups.
40. The method according to any one of the previous statements 37 to 39, wherein said crosslinked polymer is obtained by crosslinking an alkali metal carboxylate polymer comprising methacrylate groups, and preferably a methacrylated sodium alginate.
41. The method according to any one of the previous statements, wherein the crosslinking is done in the presence of a reactive monomer, preferably a reactive monomer as defined in any one of statements 8-10.
42. The method according to any one of the previous statements 37 to 40, wherein the crosslinked polymer is formed by irradiating the polymer with light, such as visible light or UV light, preferably with UV light, preferably with UV-A light, and preferably in the presence of a photo-initiator.
43. The method according to any one of the previous statements 37 to 41, wherein the crosslinked polymer is formed by using a redox initiation system, preferably such redox initiation system comprises a persulphate, such as APS (ammonium persulfate) as initiator, and is preferably done in the presence of an organic base, such as tetraacetylethylenediamine (TEMED).
44. Method for preparing a silver-containing crosslinked polymer, preferably a method according to any one of the previous statements 37 to 42, wherein said silver-containing crosslinked polymer is a silver carboxylate crosslinked polymer, the method comprising the step of
contacting an alkali metal carboxylate crosslinked polymer with a silver ion solution thereby obtaining a silver carboxylate crosslinked polymer;
   wherein said alkali metal carboxylate crosslinked polymer comprises —COO^{⊖}[alkali metal]^{⊕} groups,
   wherein said alkali metal carboxylate crosslinked polymer is obtained by crosslinking an alkali metal carboxylate polymer, having (meth)acrylate groups,
   optionally in the presence of additional (meth)acrylic acid,
and wherein said alkali metal carboxylate polymer is selected from the group comprising alkali metal polysaccharides, preferably alkali metal alginate, more preferably sodium alginate.
45. The method according to any one of the previous statements, wherein the silver ion solution is a silver nitrate solution, preferably an aqueous silver nitrate solution.
46. The method according to any one of the previous statements, wherein the silver ion (Ag^{⊕}) solution has a concentration comprised between 0.01 M and 0.10 M, preferably between 0.02 M and 0.07 M, such as between 0.04 M and 0.06 M.
47. The method according to any one of the previous statements, wherein the crosslinked polymer is contacted with the silver ion solution for at least 10 minutes, preferably at least 20 minutes, preferably at least 30 min, preferably at least 45 minutes, preferably at least 60 minutes.
48. The method according to any one of the previous statements, wherein the crosslinked polymer is contacted with the silver ion solution at a temperature of at least 0° C. to at most 60° C., preferably at least 5° C. to at most 50° C., preferably at least 10° C. to at most 40° C., preferably at least 15° C. to at most 30° C., preferably around 20° C.
49. Use of a silver-containing covalently crosslinked polymer, preferably a silver-containing crosslinked polymer according to statements 34-36, or as defined in any of previous statements 1 to 29, as an admixture in a cementitious composition.
50. The use according to the previous statement, wherein the admixture is a shrinkage reducing agent, preferably a reducing agent of autogenous shrinkage and/or of drying shrinkage.
51. The use according to any one of the previous statements, wherein the admixture is a chloride binding agent.
52. The use according to any one of the previous statements, wherein the admixture is a chloride diffusion reducing agent and/or a chloride ingress reducing agent.
53. The use according to any one of the previous statements, wherein the admixture is a steel rebar corrosion inhibitor.
54. The use according to any one of the previous statements, wherein the admixture is a crack prevention agent and/or crack healing agent.
55. The use according to any one of the previous statements, wherein the admixture is a curing agent, preferably an internal curing agent.
56. The use according to any one of the previous statements, wherein the cementitious composition is a repair mortar or a repair paste.
57. The use according to any one of the previous statements, wherein the cementitious composition is a concrete composition and/or a concrete coating composition.
58. Use of a silver-containing crosslinked polymer, preferably a silver-containing crosslinked polymer according to statements 34-36, or as defined in any of previous statements 1 to 29, as a coating agent for (coating) concrete structures.
59. Use of a silver-containing crosslinked polymer, preferably a silver-containing crosslinked polymer according to statements 34-36, or as defined in any of previous statements 1 to 29, as a chloride binding agent (chloride removal agent) during repair of a concrete structure.
60. A method for preparing a concrete material having reduced shrinkage, comprising the step of preparing said concrete material with a cementitious composition according to any one of the previous statements 1-32, or as prepared according to statement 33, and wherein preferably said reduction is measured as compared to a concrete material that is prepared with a cementitious composition without said silver-containing crosslinked polymer.
61. A method for the reduction of shrinkage in a concrete material, said method comprising the step of preparing said concrete material with a cementitious composition according to any one of the previous statements 1-32, or as prepared according to statement 33, and wherein preferably said reduction is measured as compared to a concrete material that is prepared with a cementitious composition without said silver-containing crosslinked polymer.
62. A method for preparing a concrete material having reduced chloride ion ingress and/or reduced chloride ion diffusion in said concrete material, comprising the step of preparing said concrete material with a cementitious composition according to any one of the previous statements 1-32, or as prepared according to statement 33, and wherein preferably said reduction is measured as compared to a concrete material that is prepared with a cementitious composition without said silver-containing crosslinked polymer.
63. A method for the reduction of chloride ion ingress and/or chloride ion diffusion in a concrete material, comprising the step of preparing said concrete material with a cementitious composition according to any one of the previous statements 1-32, or as prepared according to statement 33, and wherein preferably said reduction is measured as compared to a concrete material that is prepared with a cementitious composition without said silver-containing crosslinked polymer.
64. A method for preparing a concrete material having reduced steel rebar corrosion in a steel reinforced concrete material, comprising the step of preparing said steel reinforced concrete material with a cementitious composition according to any one of the previous statements 1-32, or as prepared according to statement 33, and wherein preferably said reduction is measured as compared to a steel reinforced concrete material that is prepared with a cementitious composition without said silver-containing crosslinked polymer.
65. A method for reducing steel rebar corrosion in a steel reinforced concrete material, comprising the step of preparing said steel reinforced concrete material using a cementitious composition according to any one of the previous statements 1-32, or as prepared according to statement 33, and wherein preferably said reduction is measured as compared to a steel reinforced concrete material that is prepared with a cementitious composition without said silver-containing crosslinked polymer.
66. A method for repairing damaged areas in concrete structures, said method comprising the step of filling and/or treating said damaged areas with a cementitious composition according to any one of the previous statements 1-32, or as prepared according to statement 33.
67. A method for protecting a concrete structure, said method comprising the step of coating a surface of the concrete structure with a cementitious composition according to any one of the previous statements 1-32, or as prepared according to statement 32.
68. A method for protecting an (existing) a concrete structure, comprising the step of spraying a solution of a silver-containing crosslinked polymer, preferably a silver-containing crosslinked polymer according to statements 34-36, or as defined in any of previous statements 1 to 29, over said concrete structure, thereby depositing a film of said silver-containing crosslinked polymer over the surface of the concrete structure.

In a first aspect, the present invention provides a cementitious composition, preferably suitable for reducing shrinkage in a concrete material and/or for reducing chloride ion ingress and/or diffusion, and/or for protecting steel rebars in a steel reinforced concrete material.

More particularly, the invention provides in a cementitious composition, preferably a concrete composition or a repair mortar or a repair paste or a concrete coating composition, wherein said cementitious composition comprises
one or more cementitious material(s); preferably wherein said one or more cementitious material(s) is (are) selected from the group comprising cement, fly ash, ground granulated slag, limestone, latent hydraulic materials, pozzolanic materials, geopolymers and alkali activated materials, or any combination thereof; and,
a silver-containing, crosslinked polymer, wherein the crosslinked polymer is a covalently crosslinked polymer, and preferably wherein said silver-containing, crosslinked polymer comprises -A^{⊖}Ag^{⊕} groups; wherein A^{⊖} is an anion, preferably a carboxylate anion (—COO^{⊖}) or a sulphonate anion (—SO₃^{⊖}), and
optionally, an aggregate.

wherein the silver-containing, covalently crosslinked polymer comprises at least 2.0 weight % of silver ions, with wt % expressed as compared to the total weight of the (dry) silver-containing crosslinked polymer.

The cementitious composition of the invention comprises one or more cementitious material(s); and a silver-containing, covalently crosslinked polymer. In certain embodiments such composition may further comprise an aggregate. A cementitious composition according to the invention is particularly suitable for reducing shrinkage in a concrete material or structure and/or for reducing chloride ion ingress and/or diffusion in a concrete material or structure, and/or for protecting steel rebars in a steel reinforced concrete material or structure.

In accordance with the invention, a said silver-containing crosslinked polymer as provided in the present invention comprises polymer chains, and wherein at least a part of said polymer chains are crosslinked to each other through covalent bonds. A covalently crosslinked polymer has the advantage that the crosslinking is less reversible compared to electrostatically crosslinked polymers, and is therefore more robust and durable in changing environmental conditions. As used herein, the term “covalently crosslinked polymer”, intends to refer to a polymer comprising polymer chains, wherein at least a part of said polymer chains are crosslinked to each other through covalent bonds. In certain embodiments of the present invention, the terms “covalently crosslinked polymer” and “crosslinked polymer” are used interchangeably (as synonyms). The term “crosslinking” as used in the context of the present invention therefore refers to covalent crosslinking, which is the opposite of physical crosslinking, leading to a non-covalent and reversible binding. The terms “covalently” or “covalent” or “through covalent binding or bond” are meant to refer to a covalent and non-reversible bond. The present invention is directed to a chemically crosslinked robust material (a crosslinked polymer as defined herein) that does not break down in a wide range of conditions thanks to the covalently crosslinked polymer network.

As used herein the term “cementitious material” refers to a material that is cement or a cement-like material. Preferably, a cementitious material provides plasticity, cohesive, and adhesive properties when it is mixed with water or other activators, such as alkali ions, as present in alkali activators; and that result in a formation of a rigid mass after reactions with water or the activator. In some embodiments, a cementitious material comprises a binder, such as cement, like Portland cement. In certain embodiments, a cementitious material comprises geopolymers and alkali activated materials. In some embodiments, the terms geopolymers and alkali activated materials may be used as synonyms and refer to materials that can be added to an alkaline medium to produce a cementitious material that can be used instead of Portland cement in the making of concrete. Non-limitative examples of cementitious materials that may be used in accordance with the present invention include for instance cement, fly ash, ground granulated slag, limestone, latent hydraulic materials, pozzolanic materials, geopolymers and alkali activated materials, and any combinations thereof.

As used herein, the term “aggregate” may refer to coarse-to medium-grained particulate material used in construction, including sand, gravel, crushed stone, slag, recycled concrete and geosynthetic aggregates. Preferably, the aggregates used in the compositions disclosed herein comprise sand. Preferably, the aggregates used in the compositions disclosed herein comprise sand and an aggregate selected from the list comprising gravel, crushed stone, slag, recycled concrete or combinations thereof.

It has been found that the silver, preferably silver ions, of a silver-containing, covalently crosslinked polymer, as defined herein, can bind or react with chloride ions, and form a silver chloride precipitate. In this way, a silver-containing crosslinked polymer may prevent damage from chloride ions of a cured cementitious composition or structures made from said cementitious composition. It was further observed that while and after binding and precipitating the chloride ions by the silver ions, the covalently crosslinked polymer is able to remain intact. This is advantageous as in such way, the crosslinked network of the polymer does not degrade after chloride binding, and the polymer does not leach out of the set cementitious composition or the structure, and therefore can fulfil one or more of its functions. For example, the polymer retained in the structure may further bind chloride ions, or for example, the polymer retained in the structure may keep its water absorption capacity which may help for self-sealing and self-healing of cracks in the set cementitious composition or structure.

In some embodiments, a cementitious composition according to the invention is a workable and curable cementitious composition which further comprises water, optionally comprising an alkali activator. As used herein the term “workable” refers to a cementitious composition that can be processed (handled), and for instance can be cast, moulded, 3D-printed or applied into a desired shape, preferably before the cementitious material in the composition is cured or hardened.

In certain embodiments, a cementitious composition as provided in the present invention may include a repair mortar or a repair paste. Repair mortars are typically used for restoring or replacing an original profile and function of a damaged concrete. They are used to help to repair concrete defects, improve appearance, restore structural integrity, increase durability and extend the structure's longevity. A repair mortar or repair paste according to the present invention makes it possible to repair cracks in (concrete) structures. For instance it may be directly applied to a surface of a structure having a crack so as to cover the cracked parts.

In certain embodiments, a cementitious composition as provided in the present invention may include concrete composition, i.e. a composition for making concrete and/or a concrete coating composition, i.e. a composition which may be used to, at least partly, cover (coat) a concrete structure.

Concrete may be referred in this invention as “concrete material” or as “concrete structure”, with the latter term, intending to refer to a hardened (i.e. cured) concrete material. Concrete sets and hardens as a result of a chemical reaction (hydration) between cementitious materials and water. Curing is the process of maintaining satisfactory temperature and moisture conditions in concrete long enough for hydration to develop the desired concrete properties. In certain embodiments of the invention the terms curing and setting are used interchangeably.

In some embodiments of the present invention, said silver-containing, covalently crosslinked polymer comprises -A^{⊖}Ag^{⊕} groups; wherein A is an anion, preferably a carboxylate anion (—COO^{⊖}) or a sulphonate anion (—SO₃^{⊖}). Preferably, the said silver-containing, covalently crosslinked polymer comprises carboxylate anions (—COO^{⊖}). These groups allow for an electrostatic interaction with the silver ions (Ag⁺), which allows for a reversible bond between the covalently crosslinked polymer and the silver. This way the silver ions can be exchanged for other ions, after which the silver ions may precipitate chloride ions, preventing the chloride ions to ingress and/or diffuse into the cementitious composition, and cause damage.

In some embodiments, said crosslinked polymer is obtained by crosslinking polymer chains of a polymer that comprises A^{⊖}R^{⊕} groups; wherein A^{⊖} is an carboxylate anion (—COO^{⊖}) and wherein R^{⊕} is a monovalent cation, preferably H⁺ or an alkali metal cation. In some other embodiments, said crosslinked polymer is obtained by crosslinking polymer chains of a polymer that comprises A^{⊖}R^{⊕} groups; wherein A^{⊖} is a sulphonate anion (—SO₃^{⊖}), and wherein R^{⊕} is a monovalent cation, preferably H⁺ or an alkali metal cation. In some other embodiments, said crosslinked polymer is obtained by crosslinking polymer chains of a polymer that comprises A^{⊖}R^{⊕} groups; wherein A^{⊖} is a carboxylate anion (—COO^{⊖}) or a sulphonate anion (—SO₃^{⊖}), and wherein R^{⊕} is an alkali metal cation. Preferred examples of alkali metal include lithium, sodium or potassium, more preferably sodium. The advantage of the alkali metal cations is that these comprise a single positive charge. This may result in an easier exchange of silver ions, from silver containing covalently crosslinked polymer, and may make the silver containing covalently crosslinked polymer easier to handle as there occurs less gel-formation compared to for example double positively charged ions, like Ca²⁺ ions.

In certain embodiments of the invention, a crosslinked polymer is obtained by:
(i) crosslinking polymer chains of a polymer comprising said -A^{⊖}R^{⊕} groups, and further comprising vinyl groups and/or (meth)acrylate groups, and/or,
(ii) by crosslinking polymer chains of a polymer in the presence of additional reactive monomer.

Thus, a crosslinked polymer may be obtained by crosslinking polymer chains of a polymer that comprises vinyl groups and/or (meth)acrylate groups, preferably (meth)acrylate groups. These groups have the advantage that they can react with each other to form crosslinks under orthogonal reaction conditions, compared to other possible functional groups on the polymer chains, especially orthogonal compared to carboxylate anion (—COO^{⊖}) or a sulphonate anion (—SO₃^{⊖}) that may be present on the polymer chains before crosslinking. (Meth)acrylate groups may be preferred as the double bond in such groups is more reactive by the presence of the ester functionality, compared to vinyl groups as such. Upon crosslinking, which can for example be photo-initiated or redox-initiated, stable carbon-carbon bonds are formed, making the crosslinking durable and robust. In some embodiment, wherein vinyl groups are present on the polymer chains, crosslinking may be achieved upon reaction with thiols, forming thiol-ene crosslinks between the polymer chains.

Alternatively or additionally therewith, in certain embodiments of the invention, a crosslinked polymer may be obtained by crosslinking polymer chains of a polymer in the presence of additional reactive monomer. As used herein the term “reactive monomer” refers to a monomer that may be incorporated into a crosslinking reaction, preferably by forming cross linking polymer chains.

In some embodiments, a reactive monomer as used herein is a compound comprising a vinyl group or a —CH═CHMe group, preferably a vinyl group. These groups may make the reactive monomer participate in the crosslinking reaction between vinyl groups and/or (meth)acrylate groups present on the polymer chains.

In some embodiments, a reactive monomer as used herein is a compound comprising a carboxyl group or a sulfonate group, preferably a carboxyl group. This may lead to the formation of polyacid chains during the crosslinking. These polyacid chains may increase the silver ion binding capacity of the covalently crosslinked polymer. Even more, these polyacid chains may be hydrated by large amounts of water, in the absence of silver ions (which can occur after chloride precipitation). This may allow the crosslinked polymer to swell in the presence of water, so that such polymers may have self-healing and/or self-sealing properties in a set cementitious composition according to the invention. The large amounts of water hydrated to the polymer may further assist in the curing of the cementitious composition, making such polymers suitable as internal curing agents.

In some preferred embodiments, said reactive monomer is selected from the group comprising (meth)acrylic acid, (meth)acrylamide, 2-(di(m)ethylamino)ethyl (meth)acrylate, N-[3-(dimethylamino) propyl]methacrylamide, and 2-Acrylamido-2-methyl-1-propanesulfonic acid; preferably wherein the reactive monomer is (meth)acrylic acid. Preferably, said reactive monomer is acrylic acid.

The polymer as applied and defined in the present invention has particular properties.

In some embodiments, the polymer that is crosslinked is a hydrophilic polymer. Hydrophilic polymers are those polymers which dissolve in, or are swollen by, water. The use of polymer with this property may result in better incorporation into a workable cementitious composition as defined herein. It has been found that as long as the silver is bound to the silver containing, covalently crosslinked polymer, swelling of the polymer by water uptake is lower compared to the swelling of the same covalently crosslinked polymer without the silver. Hence, upon preparation of a workable cementitious composition according to an embodiment of the invention, the silver containing, covalently crosslinked polymer in such cementitious composition will swell and will form a gel-like particle. After setting and drying, these gel-like particles will dry out, shrink and leave a void in the set cementitious composition. If the same procedure would be done, with the covalently crosslinked polymer without the silver present, these gel-like particle would be much larger, leaving larger voids, and therefore the mechanical strength of the set cementitious composition would be far lower.

One of the advantages of the invention is that after curing of the cementitious composition, the covalently crosslinked polymer remains intact, and therefore remains present in the voids. Upon contact with water the covalently crosslinked polymer can swell again, thereby sealing the void for more water to penetrate the set cementitious composition. This sealing capacity will only increase the more silver has been removed due to chloride binding and precipitation. This attributes self-healing properties to the covalently crosslinked polymer of the invention.

In some embodiments of the invention, the polymer that is crosslinked is a polyol, a polyamine or a polyacid, preferably a polyacid. These polymers may allow easy (partially) functionalisation with cross-linkable groups, such as (meth)acrylate groups. Even more, these polymers as such may be capable of absorbing large amounts of water, and this may result in self-healing properties on the set cementitious composition according to the invention.

In certain preferred embodiments, the polymer that is crosslinked in accordance with the invention is a polysaccharide or a salt derivative thereof, preferably a polysaccharide comprising sugar moieties wherein the sugar moieties comprise an acid functionality, or a salt derivative thereof, preferably an alkali metal salt derivative thereof, more preferably an alginate or a salt derivative thereof, preferably an alkali metal salt derivative thereof. Polymers like these may have superabsorbent properties. In one example, the polymer is a sodium alginate.

In certain other preferred embodiments, the polymer that is crosslinked is a synthetic polymer having anionic groups. The term “synthetic” in this respect, is used as opposite to “naturally occurring in nature”, and intends to refer to polymers that are man-made through chemical reactions. Preferably, the polymer that is crosslinked is a polymer that comprises carboxylate anion (—COO^{⊖}) or a sulphonate anion (—SO₃^{⊖}) groups, and preferably is poly(aspartic acid) or a salt derivative thereof, preferably an alkali metal salt derivative thereof.

In some embodiments, the alkali metal is lithium, sodium or potassium, preferably sodium. These ions may prevent electrostatic crosslinking.

In a preferred example, the polymer that is crosslinked is an alkali metal carboxylate polymer that comprises (meth)acrylate groups, and preferably is a methacrylated sodium alginate. Such a polymer may have superabsorbent properties.

In some embodiments, the crosslinked polymer is a superabsorbent polymer, or wherein the silver-containing, covalently crosslinked polymer is a silver-containing superabsorbent polymer. The term “superabsorbent polymer” or “SAP” is known in the art, and are water-absorbing polymers that can absorb and retain extremely large amounts of a liquid relative to their own mass. Such polymers may be used as additives or admixtures in cementitious compositions, where their ability to swell to a large volume by the absorption of water, can be used (1) as internal curing agent, being a material which stores water in fresh concrete and gradually releases it over time as the concrete dries out hence avoiding self-desiccation and autogenous shrinkage cracking; (2) to fill up cracks formed in a cementitious structure. As the cracks are filled by the swollen superabsorbent polymer, diffusion of harmful substances through cracks, located deeper in the cementitious structure, may be prevented. In the art, such behaviour is known as “self-sealing”; (3) when they are present at the crack walls, to attract moisture from the air or store liquid water and release it slowly towards the concrete matrix, leading to hydration of unhydrated binder particles and stimulating precipitation of calcium carbonate; which is known as “self-healing” or “self-repairing”. For example, a self-healing concrete is capable to repair its (micro-) cracks on its own, preferably autogenously or autonomously.

In some embodiments, the swelling capacity (g/g) of the crosslinked polymer without the silver ions is at least 10.0, preferably at least 25.0, preferably at least 50.0, preferably at least 75.0, preferably at least 100.0, preferably at least 125.0, preferably at least 150.0, preferably in deionised water or demineralised water, preferably deionised water. The swelling capacity as defined herein, may be measured by a tea-bag method in deionised water as described in Snoeck et al. ‘Recommendation of RILEM TC 260-RSC: testing sorption by superabsorbent polymers (SAP) prior to implementations in cement-based materials; Materials and Structures (2018) 51:116’. Preferably, the deionised water is Type I water according to ASTM (D1193-91). Water known as Milli-Q® water falls under Type I water according to ASTM (D1193-91); Milli-Q® water may be a preferred medium to determine the swelling capacities disclosed herein. Such swelling capacities may result in self-sealing and self-healing properties.

In some embodiments, the polymer (before crosslinking) has a Mw of at least 20,000 g/mol; such as a Mw of at least 20.000 g/mol to at most 750,000 g/mol, preferably at least 50,000 to at most 500,000 g/mol, preferably at least 100,000 to at most 250,000 g/mol.

In some embodiments, the polymer (before crosslinking) has a Mn of 15,000; such as a Mn of at least 15,000 g/mol to at most 70,000 g/mol, preferably at least 20,000 to at most 50,000 g/mol, preferably at least 30,000 to at most 40,000 g/mol.

In some embodiments, the polymer (before crosslinking) has at least 1.0, preferably at least 3.0, preferably at least 5.0, preferably at least 7.0, preferably at least 9.0 (meth)acryl substituents per 100 monomers, as determined by 1H-NMR spectroscopy. These polymers may provide the necessary crosslinking density to provide the mechanical stability of the crosslinked polymer.

In some embodiments, the polymer (before crosslinking) has at least 1.0 to at most 25.0, preferably at least 3.0 to at most 20.0, preferably at least 5.0 to at most 18.0, preferably at least 7.0 to at most 16.0, preferably at least 9.0 to at most 15.0 (meth)acryl substituents per 100 monomers, as determined by 1H-NMR spectroscopy. Too much crosslinking may interfere with the swelling capacities of the covalently crosslinked polymer.

In some embodiments, the polymer (that is crosslinked) comprises at least 0.2, preferably at least 0.4, preferably at least 0.5, preferably at least 0.6, preferably at least 0.8, preferably at least 1.0 carboxylate anions (—COO^{⊖}) or a sulphonate anions (—SO₃^{⊖}) per monomer. The number of anionic groups may be determined by titration.

In some preferred embodiments, a silver-containing, covalently crosslinked polymer of the invention is a silver carboxylate crosslinked polymer, wherein said crosslinked polymer comprises —COO^{⊖}Ag^{⊕} groups, and wherein said crosslinked polymer is obtained by crosslinking an alkali metal carboxylate polymer, having (meth)acrylate groups, optionally in the presence of additional (meth)acrylic acid, and wherein said alkali metal carboxylate polymer is selected from the group comprising alkali metal polysaccharides, preferably alkali metal alginate, more preferably sodium alginate. In one example, a silver-containing, covalently crosslinked polymer of the invention is a silver carboxylate crosslinked polymer, wherein said crosslinked polymer comprises —COO^{⊖}Ag^{⊕} groups, and wherein said crosslinked polymer is obtained by crosslinking a sodium carboxylate polymer, having (meth)acrylate groups, optionally in the presence of additional (meth)acrylic acid.

In some embodiments, the silver-containing, covalently crosslinked polymer comprises at least 2.0 weight % of silver ions, or at least 5.0 weight % of silver ions, or at least 7.0 weight % of silver ions, or at least 10.0 weight % of silver ions, or at least 12.0 weight % silver ions, or at least 14.0 weight % of silver ions, with wt % expressed as compared to the total weight of the (dry) silver containing, covalently crosslinked polymer. Beside the ability of the silver to bind and precipitate chloride ions, such amount of silver ions may limit swelling of the silver-containing, covalently crosslinked polymer upon the addition of water to the cementitious composition, thereby increasing the mechanical strength of the set cementitious composition. Amounts of silver ions below these values may be too low to still efficiency bind and precipitate chloride ions.

In some embodiments, the silver-containing, covalently crosslinked polymer comprises at least 2.0 weight % to at most 30.0 weight % of silver ions, or at least 5.0 weight % to at most 25.0 weight % of silver ions, or at least 7.0 weight % to at most 22.0 weight % of silver ions, or at least 10.0 weight % to at most 20.0 weight % of silver ions, or at least 12.0 weight % to at most 18.0 weight % of silver ions, or at least 14.0 weight % to at most 16.0 weight % of silver ions, with wt % expressed as compared to the total weight of the (dry) silver-containing, covalently crosslinked polymer. Depending on the nature of the covalently crosslinked polymer, in composition and crosslinking density, the higher amounts of silver ions may be difficult to be achieved. As silver is an expensive ingredient, the higher amounts of silver ions might not be economically interesting in the context of cementitious compositions.

In some embodiments, the cementitious composition comprises at least 0.10 weight % to at most 5.00 weight %, preferably at least 0.20 weight % to at most 3.00 weight %, preferably at least 0.30 weight % to at most 2.00 weight %, preferably at least 0.40 weight % to at most 1.00 weight %, with wt % based on the total weight of the cementitious composition, of said silver-containing, covalently crosslinked polymer.

In another aspect, the invention also provides in a method for making a cementitious composition, the method comprising the steps of:
a) preparing a cementitious composition by mixing one or more cementitious material(s), preferably as defined herein, a silver-containing covalently crosslinked polymer, preferably as defined in an embodiment disclosed herein, and optionally aggregate(s), and,
b) optionally, further admixing said cementitious composition with a suitable amount of water, optionally comprising an alkali activator, thereby obtaining a workable and curable cementitious composition.

In another aspect, the invention also provides in a method for making a cementitious composition, the method comprising the steps of:
a) preparing a cementitious composition by mixing:
   a silver-containing covalently crosslinked polymer, wherein the crosslinked polymer is a covalently crosslinked polymer, and wherein the silver-containing, covalently crosslinked polymer comprises at least 2.0 weight % of silver ions, with wt % expressed as compared to the total weight of the (dry) silver-containing crosslinked polymer; and,
   one or more cementitious material(s), preferably as defined herein, preferably as defined in an embodiment disclosed herein, and
   optionally aggregate(s);
b) optionally, further admixing said cementitious composition with a suitable amount of water, optionally comprising an alkali activator, thereby obtaining a workable and curable cementitious composition.

In some embodiments, the silver-containing, covalently crosslinked polymer is pre-soaked in water. In some embodiments, the silver-containing, covalently crosslinked polymer is saturated with water. Especially when the silver-containing, covalently crosslinked polymer can absorb large amounts of water, the water added via the pre-soaked silver-containing, covalently crosslinked polymer may be enough to start the curing process of the cementitious composition.

In some embodiments of the invention, a method is provided comprising the steps of:
a) preparing a cementitious composition by mixing one or more cementitious material(s), optionally aggregate(s), and a dry silver-containing, covalently crosslinked polymer, preferably as defined in an embodiment disclosed herein; and,
b) further admixing said cementitious composition with a suitable amount of water, optionally comprising an alkali activator, thereby obtaining a workable and curable cementitious composition.

In some other embodiments of the invention, a method is provided comprising the steps of:
a) pre-soaking a silver-containing, covalently crosslinked polymer, preferably as defined in an embodiment disclosed herein, in water thereby obtaining a pre-soaked silver-containing, covalently crosslinked polymer;
b) preparing a cementitious composition by mixing one or more cementitious material(s), optionally aggregates, and said pre-soaked silver-containing, covalently crosslinked polymer; and,
c) optionally, further admixing said cementitious composition with a suitable amount of water.

The invention further provides a (concrete) structure comprising a cementitious composition as provided herein and preferably a cementitious composition as provided herein that is cured. For instance, the structure can be a structure such as a plate, shaft, column, architectural structure, a beam or a slab, etc.

The invention also provides a method for making a (concrete) structure from a cementitious composition, the method comprising the step of:
a) preparing a cementitious composition as defined in an embodiment described herein; and,
b) pouring said cementitious composition in a mould, wherein the mould optionally comprises steel rebars; or, printing said cementitious composition optionally mould free and optionally around steel rebars; and
d) curing the cementitious composition for a suitable curing time, thereby allowing the cementitious composition to set and harden, thereby forming a (′concrete) structure.

The invention further relates to a silver-containing, covalently crosslinked polymer.

In certain embodiments the invention provides a silver-containing, crosslinked polymer, wherein the crosslinked polymer is a covalently crosslinked polymer, and wherein said crosslinked polymer comprises -A^{⊖}Ag^{⊕} groups; wherein A^{⊖} is an anion, preferably a carboxylate anion (—COO^{⊖}) or a sulphonate anion (—SO₃^{⊖}). Phrased differently, in certain embodiments the invention provides a silver-containing, crosslinked polymer, wherein said crosslinked polymer comprises polymer chains, and wherein at least a part of said polymer chains are crosslinked to each other through covalent bonds; and wherein said crosslinked polymer comprises -A^{⊖}Ag^{⊕} groups; wherein A^{⊖} is an anion, preferably a carboxylate anion (—COO^{⊖}) or a sulphonate anion (—SO₃^{⊖}). Said silver-containing, covalently crosslinked polymer is preferably as defined as disclosed herein.

In some embodiments, a silver-containing, covalently crosslinked polymer is provided which is a polymer as represented by formula (I) or (II),

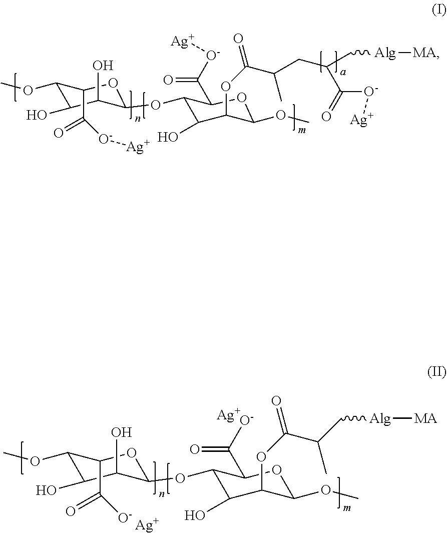

wherein Alg-MA stands for the groups represented by Formula (III):

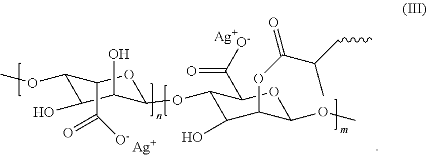

and wherein n and m are an integer. In some embodiments, the ratio of n over m is at least 0.30 to at most 1.50, preferably at least 0.40 to at most 1.20, preferably at least 0.50 to at most 1.10, preferably at least 0.60 to at most 1.05, preferably at least 0.65 to at most 1.00.

In some embodiments, the ratio of n over m is at least 0.90, preferably at least 0.95, preferably at least 1.00, preferably at least 1.05, preferably at least 1.10, preferably at least 1.20, preferably at least 1.30, preferably at least 1.40, preferably at least 1.50. These higher n/m ratio's may favour silver binding to the covalently crosslinked polymer.

The invention may further provide in a method for preparing a silver-containing, covalently crosslinked polymer, preferably a silver-containing, covalently crosslinked polymer according to an embodiment described herein, comprising the steps of:
a) providing a crosslinked polymer,
   wherein the crosslinked polymer comprises polymer chains, and wherein at least a part of said polymer chain is crosslinked to each other through covalent bonds;
   wherein the crosslinked polymer comprises -A^{⊖}R^{⊕} groups, wherein A^{⊖} is an anion, preferably a carboxylate anion (—COO^{⊖}) or a sulphonate anion (—SO₃^{⊖}), and R^{⊕} is a cation, preferably a hydrogen or an alkali metal cation; and
b) contacting said crosslinked polymer with a silver ion (Ag^{⊕}) solution, thereby forming said silver-containing, covalently crosslinked polymer comprising -A^{⊖}Ag^{⊕} groups.

The term “contacting” as used in the context of the present invention may also be considered to mean “incubating”.

In some embodiments, said crosslinked polymer is obtained by crosslinking polymer chains of a polymer comprising said -A^{⊖}R^{⊕} groups.

In some embodiments, said crosslinked polymer is obtained by crosslinking polymer chains of a polymer comprising said -A^{⊖}R^{⊕} groups and further having vinyl groups and/or (meth)acrylate groups.

In some embodiments, said crosslinked polymer is obtained by crosslinking an alkali metal carboxylate polymer comprising methacrylate groups, and preferably a methacrylated sodium alginate.

In some embodiments, the crosslinking is done in the presence of a reactive monomer, preferably a reactive monomer as disclosed herein.

In some embodiments, the crosslinked polymer is formed by irradiating the polymer with light (visible light) or UV light, preferably with UV light, preferably with UV-A light, and preferably in the presence of a photo-initiator.

In some embodiments, the crosslinked polymer is formed using a redox initiation system, preferably by the addition of a persulphate as initiator, such as APS (ammonium persulfate), preferably in the presence of an organic base, such as tetraacetylethylenediamine (TEMED).

In some embodiments, said silver-containing, covalently crosslinked polymer is a silver carboxylate crosslinked polymer, and the method comprises the step of
contacting an alkali metal carboxylate crosslinked polymer with a silver ion solution thereby obtaining a silver carboxylate crosslinked polymer;
   wherein said alkali metal carboxylate crosslinked polymer comprises —COO^{⊖}[alkali metal]^{⊕} groups,
   wherein said alkali metal carboxylate crosslinked polymer is obtained by crosslinking an alkali metal carboxylate polymer, having (meth)acrylate groups, optionally in the presence of additional (meth)acrylic acid,

and wherein said alkali metal carboxylate polymer is selected from the group comprising alkali metal polysaccharides, preferably alkali metal alginate, more preferably sodium alginate.

In one example, said silver-containing, covalently crosslinked polymer is preparing by the steps of:
crosslinking polymer chains of a polymer comprising said -A^{⊖}R^{⊕} groups and further having vinyl groups and/or (meth)acrylate groups, by irradiating the polymer with light, preferably with UV light, preferably with UV-A light, and preferably in the presence of a photo-initiator.

In one example, said silver-containing, covalently crosslinked polymer is preparing by the steps of:
crosslinking polymer chains of a polymer comprising said -A^{⊖}R^{⊕} groups and further having vinyl groups and/or (meth)acrylate groups, by contacting the polymer with a redox initiation system, preferably such redox initiation system comprises a persulphate, such as APS (ammonium persulfate) as initiator, and is preferably done in the presence of an organic base, such as tetraacetylethylenediamine (TEMED).

In some embodiments, the silver ion solution is a silver nitrate solution, preferably an aqueous silver nitrate solution.

In some embodiments, the silver ion (Ag) solution has a concentration comprised between 0.01 M and 0.10 M, preferably between 0.02 M and 0.07 M, preferably 0.04 M and 0.06 M.

In some embodiments, the crosslinked polymer is contacted with the silver ion solution for at least 10 minutes, preferably at least 20 minutes, preferably at least 30 min, preferably at least 45 minutes, preferably at least 60 minutes.

In some embodiments, the crosslinked polymer is contacted with the silver ion solution at a temperature of at least 0° C. to at most 60° C., preferably at least 5° C. to at most 50° C., preferably at least 10° C. to at most 40° C., preferably at least 15° C. to at most 30° C., preferably around 20° C.

The invention further provides different uses of a silver-containing, covalently crosslinked polymer, preferably a silver-containing, covalently crosslinked polymer according to an embodiment described herein.

In one embodiment invention relates to the use of a silver-containing covalently crosslinked polymer, preferably a silver-containing crosslinked polymer according to an embodiment described herein as an admixture in a cementitious composition.

As used herein, the term “admixture” refers to a material added to the cementitious composition, either before or during mixing, to modify its properties in some way. The term “addition” or “additive” applies to materials that are interground or blended with the cementitious material either to aid in manufacture or to modify the way the cementitious composition or cementitious structure made from said cementitious composition, behaves. In certain embodiments, the term “admixture” may encompass additives and replacements.

In certain preferred embodiments of the present invention that said admixture (i.e. a silver-containing covalently crosslinked polymer, and preferably a silver-containing crosslinked polymer he cementitious composition as described herein) is used in a cementitious composition (preferably as defined herein) in an amount of at least 0.10 weight % to at most 5.00 weight %, preferably at least 0.20 weight % to at most 3.00 weight %, preferably at least 0.30 weight % to at most 2.00 weight %, preferably at least 0.40 weight % to at most 1.00 weight %, with weight % based on the total weight of the cementitious composition.

In some embodiments, the admixture is a shrinkage reducing agent, preferably a reducing agent of drying shrinkage, of autogenous shrinkage and/or of total shrinkage, preferably a reducing agent of autogenous shrinkage.

As used herein the term “drying shrinkage” refers to the shrinkage resulting from changes in the volume of cementitious composition when loss of moisture to the environment takes place during drying and/or curing.

As used herein the term “autogenous shrinkage” refers to the shrinkage resulting from cementitious material hydration and the formation of hydration products. When a cementitious material is exposed to water and hydration starts to take place, hydration products may precipitate in the water-filled spaces between the particles in the system. As a result, hydrostatic tension forces are formed by the water in the remaining small capillaries, reducing the distance between the particles, and therefore causing shrinkage.

As used herein, the term “total shrinkage” is understood to include the autogenous shrinkage and the drying shrinkage.

In some embodiments, the admixture is a chloride binding agent. The chloride binding agent binds chloride ions, for example by forming a precipitate such as AgCl, and therefore may prevent diffusion of the chloride ions into the (hardened) cementitious composition. Hence, the admixture may be a chloride diffusion reducing agent and/or a chloride ingress reducing agent. The admixture may prevent chloride migration in a (hardened) cementitious composition.

As used herein the term “chloride ingress” refers to the process of chloride ions penetrating into a cementitious (concrete) structure, which may be harmful for said structure or steel rebar embedded inside the structure. Chloride ingress may be caused by capillary absorption, migration, permeation and diffusion of chloride ions; however, chloride diffusion may be the main driving force behind chloride ingress.

In some embodiments, the admixture is a steel rebar corrosion inhibitor. In some embodiments, the admixture or the silver containing, covalently crosslinked polymer may stop or retard corrosion of steel rebars inside a (hardened) cementitious composition.

In some embodiments, the admixture is a crack prevention agent. As used herein the term “crack prevention agent” is an agent that may prevent the formation of cracks in a cementitious structure, such as cracks formed by shrinkage of the cementitious structure.

In some embodiments, the admixture is a crack healing agent. In some embodiments, the admixture is a self-healing agent.

As used herein, the term “self-sealing” is the ability of cementitious structure to seal or heal at least some of the cracks that may be formed in the structure after curing or upon use of the structure.

As used herein, the term “self-healing” is the ability of a cementitious structure to attract moisture from the air or store liquid water in cracks and release it slowly towards the concrete matrix, leading to hydration of unhydrated binder particles and stimulating precipitation of calcium carbonate, thereby at least partially filling up the cracks.

In some embodiments, the admixture is a curing agent, preferably an internal curing agent.

As used herein the term “internal curing agent” is a material which stores water in cementitious composition and releases it over time to support curing. Internal water curing (or water entrainment) is the incorporation of a curing agent into freshly prepared cementitious structure serving as an internal reservoir of water, which can gradually release water as the cementitious structure dries out. Internal curing may help to avoid self-desiccation of the cementitious material, which is the reduction in the internal relative humidity of a sealed system when vapor filled pores are generated. This occurs when chemical shrinkage takes place at the stage where the paste matrix has developed a self-supportive skeleton, and the chemical shrinkage is larger than the autogenous shrinkage.

In some embodiments, the cementitious composition is a repair mortar or a repair paste.

The invention may provide in the use of a silver-containing, covalently crosslinked polymer, preferably a silver-containing, covalently crosslinked polymer according to an embodiment described herein as a coating agent for concrete structures.

The invention may provide in the use of a silver-containing, covalently crosslinked polymer, preferably a silver-containing, covalently crosslinked polymer according to an embodiment described herein as a chloride removal agent during concrete repair.

As used herein, the term “chloride removal agent” is an agent that can remove chloride ions form the surface from a cementitious structure, from the surface layer from a cementitious structure or from the internal matrix of a cementitious structure.

The invention may further provide a method
for the reduction of shrinkage in a concrete material and/or
for the reduction of chloride ion ingress and/or diffusion in concrete material,
and/or for reducing steel rebar corrosion in a steel reinforced concrete material,

said method comprising the step of preparing said concrete material with a cementitious composition according to an embodiment described herein,

and preferably wherein said reduction is measured as compared to a concrete material that is prepared with a cementitious composition without said silver-containing crosslinked polymer.

The invention may further provide a method for repairing damaged areas in concrete structures said method comprising the step of filling and/or treating said damaged areas with a cementitious composition according to an embodiment described herein.

In certain embodiments, the treatment of concrete structures may be limited to those damaged areas of the structure and may be local. In certain embodiments, the present invention also provides for the treatment of larger parts of concrete structures, including non-damaged parts.

In certain embodiments, the invention also provides a method for protecting a concrete structure, said method comprising the step of coating a surface of the concrete structure with a cementitious composition as defined herein, or as prepared as described herein. For instance, a concrete structure may receive an overlay (or be coated with) of a concrete composition as described herein.

The invention may also provide in a method for protecting a concrete structure, comprising the step of spraying a solution of a silver-containing, covalently crosslinked polymer, over said concrete structure, or a part thereof, thereby depositing a film of said silver-containing, covalently crosslinked polymer over the surface of the concrete structure; wherein the silver-containing, covalently crosslinked polymer is preferably a silver-containing, covalently crosslinked polymer according to an embodiment described herein.

The following examples serve to merely illustrate the invention and should not be construed as limiting its scope in any way. While the invention has been shown in only some of its forms, it should be apparent to those skilled in the art that it is not so limited, but is susceptible to various changes and modifications without departing from the scope of the invention.

### EXAMPLES

### Methods

¹H NMR spectroscopy of the non-crosslinked polymers mentioned herein can be performed in solution. For crosslinked polymers mentioned herein, solid state high-resolution magic-angle spinning (HR-MAS) ¹H-NMR spectroscopy may be used.

### Example 1: Synthesis of a Silver Containing, Methacrylated Crosslinked Polyalginate (Cross-Alg-MA-Ag)

The following example describes the synthesis of a silver containing crosslinked polymer according to the present invention. In this example, the synthesis of a silver containing, methacrylated crosslinked polyalginate (Cross-Alg-MA-Ag) is illustrated by means of scheme 1.1.

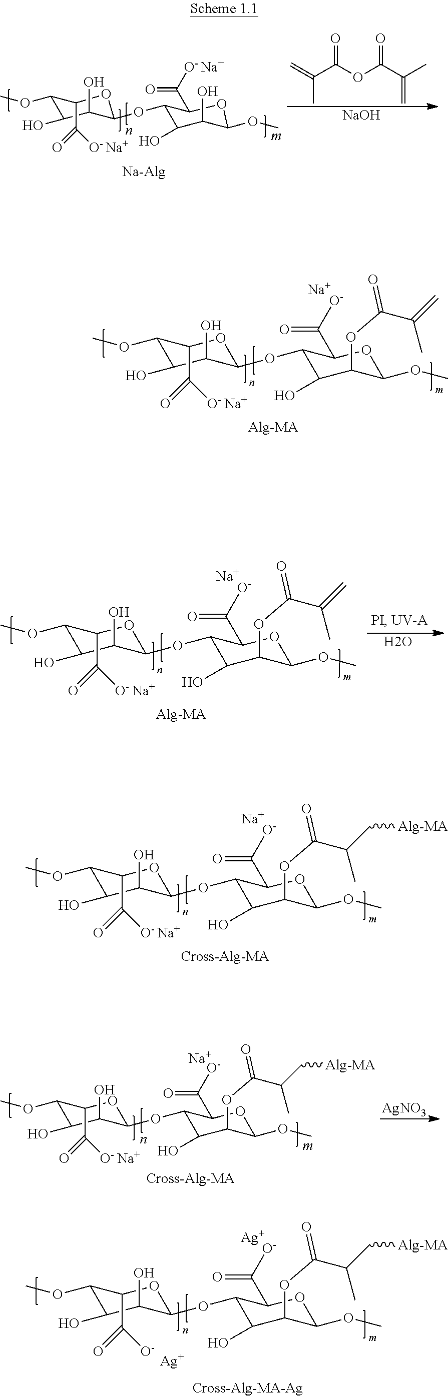

Step 1: Synthesis of Methacrylated polyalginate (Alg-MA); see first reaction of Scheme 1.1 20 g sodium alginate (Na-Alg) purchased from Sigma-Aldrich (Bornem, Belgium) (0.010095 mol OH functionalities/g) were dissolved in 1 L Milli-Q® H₂O under mechanical stirring. Once dissolved, 1 eq. (30.1 ml, 202.1 mmol) methacrylic anhydride was added dropwise over a time span of 30 min. A NaOH 5 M solution was used to neutralize the produced methacrylic acid and maintain the pH at 8.

The reaction mixture was shielded from light and left stirring for 2 days, then dialyzed using dialysis membranes 3.5 kDa MWCO in a Milli-RO bath for 3 days, while refreshing the water every 24 hours. Afterwards, the dialyzed material was concentrated under rotary evaporation, frozen and lyophilized, to obtain the product (Alg-MA) as a soft white porous material.

The extent of methacrylation of the —OH groups of the alginates, referred to herein as Degree of Substitution (DS) was determined via 1H-NMR spectroscopy. Briefly, the DS per repeating unit can be expressed as the adjusted ratio between the reference alginate peak from glucuronic acid at 4.97 ppm and the peaks of the vinylic protons of the methacrylate group at 5.73 ppm and 6.16 ppm (see Equation 1-1). Due to the presence of mannuronic acid (4.58 ppm) a correction is necessary to calculate the proportion of glucuronic acid to the total amount of monomers of Na-Alg (see Equation 1-2).

$$DS [ \% ] = G * \frac{[ \frac{{I}_{5.73 ppm} + {I}_{6.16 ppm}}{2} ]}{{I}_{4.97 ppm}} \qquad Equation 1 - 1$$

$$G = \frac{{I}_{4.97 ppm}}{{I}_{4.58 ppm} + {I}_{4.97 ppm}} \qquad Equation 1 - 2$$

Step 2: Formation of crosslinked Alg-MA (Cross-Alg-MA); see second reaction of Scheme 1.1 Alg-MA was dissolved in Milli-Q® H₂O to make a 5 wt % solution, BASF Irgacure®2959 (a photo initiator) was added in a 20 mol % ratio with respect to the methacrylate groups present, and the solution was placed for 30 minutes under UV-A irradiation from both sides (365 nm, 14-15 mW/cm²). The resulting product was frozen, freeze-dried and manually ground by using mortar and pestle to obtain cross-linked Alg-MA particles (Cross-Alg-MA).

Step 3; Ag+ incorporation (Cross-Alg-MA-Ag); see third reaction of Scheme 1.1 A 0.05 M AgNO₃ solution was prepared by dissolving AgNO₃ supplied by Carlroth in Milli-Q® H₂O. Cross-Alg-MA particles were added to AgNO₃ solution in 10 g/L ratios, then stirred for 1 h, filtered, washed 3 times with Milli-Q® H₂O, frozen, freeze-dried and ground manually to fine powders by using mortar and pestle. The obtained polymer comprises 15.61 wt % of silver ions with wt % expressed as compared to the total weight of the (dry) silver-containing crosslinked polymer.

Incorporation and saturation of the Ag⁺ in the cross-Alg-MA was confirmed by titrating the leftover solution after the particles were filtered off. To this end, 5 ml aliquots of the leftover solution were titrated in triplicate by adding NaCl 0.05 M to provide an equimolar amount of CI with respect to the mmol of Ag⁺ in 5 ml of the original AgNO₃ solution. Subsequently, 0.5 ml of a 5 wt. % aq. K₂CrO₄ indicator solution was added to each sample and the titration was performed with AgNO₃ 0.05 M under continuous stirring.

Reaction of Cross-Alg-MA-Ag with Chloride Ions

The reaction depicted in Scheme 1.2 intends to illustrate the effect of reacting a polymer according to the invention with chloride ions. Upon contact between Cross-Alg-MA-Ag and a chloride ion solution (in this example a NaCl solution), the silver ions of the Cross-Alg-MA-Ag will form a precipitate, leaving behind the Cross-Alg-MA sodium salt, which can swell up more than the original silver salt.

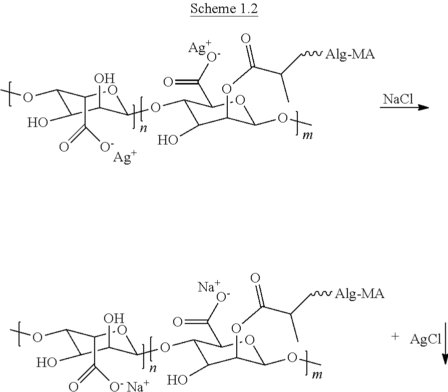

### Example 2: Synthesis of Silver Containing, Polyacid Grafted Methacrylated Crosslinked Polyalginate (Cross-PA-Alg-MA-Ag)

The following example describes the synthesis of another silver containing crosslinked polymer according to the present invention. In this example, the synthesis of a silver containing, polyacid grafted methacrylated crosslinked polyalginate (Cross-PA-Alg-MA-Ag) is illustrated by means of scheme 2.1.

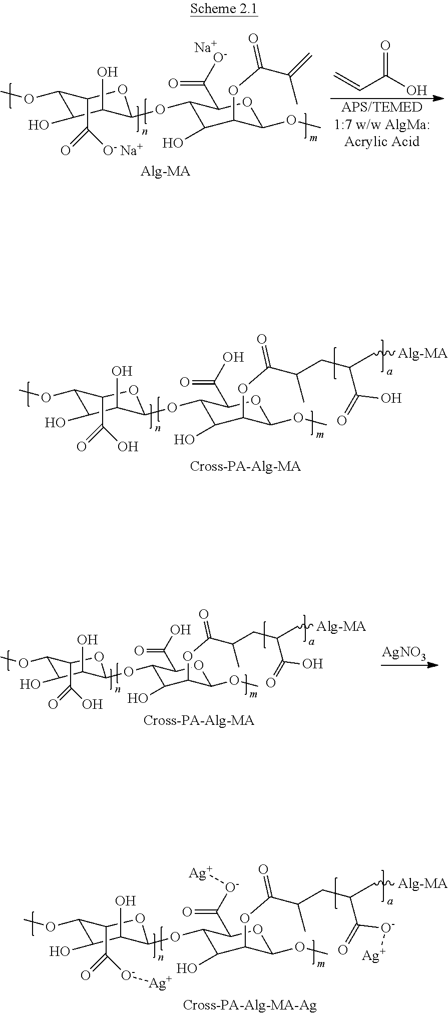

### Step 1: Formation of Polyacid Crosslinked Alg-MA (Cross-PA-Alg-MA); See First Reaction of Scheme 2.1

1% Alg-MA solution in Milli-Q® H₂O was made and the flask was three times purged with vacuum/argon cycles. Acrylic acid was added in a 7% w/w ratio in the solution followed by the addition of 2% w/w N,N,N′,N′-Tetramethylethylene-diamine (TEMED), Acros Organics (Geel, Belgium) with respect to the combined weight of the Alg-MA and acrylic acid. After 15 min, the temperature was set to 45° C., and 2% w/w the redox initiator pair ammonium persulfate (APS) was added from a 10 wt % stock solution in H₂O. After 20-30 min the onset of gelation was observed, and the reaction was left to progress overnight for 16 h. The product was removed from the flask, stirred in a 10-fold excess of demineralized water for 24 h (to remove unreacted monomers), washed with more demineralized water, frozen, freeze-dried and milled using an IKA A 11 basic Analytical mill, provided Cross-PA-Alg-MA.

### Step 2: Ag⁺ Incorporation (Cross-PA-Alg-MA-Ag); See Second Reaction of Scheme 2.1

A 0.05 M AgNO₃ was prepared by dissolving AgNO₃ supplied by Carlroth in Milli-Q® H₂O. Cross-PA-Alg-MA particles were added to AgNO₃ solution in 10 g/L ratios, then stirred for 1 h, filtered, washed 3 times with Milli-Q® H₂O, frozen, freeze-dried and ground manually to fine powders by using mortar and pestle. The obtained polymer comprises 14.01 wt % of silver ions with wt % expressed as compared to the total weight of the (dry) silver-containing crosslinked polymer.

Reaction of Cross-PA-Alg-MA-Ag with Chloride Ions

The reaction depicted in Scheme 2.2 intends to illustrate the effect of reacting a polymer according to the invention with chloride ions. Upon contact between Cross-PA-Alg-MA-Ag and a chloride ion solution (in this example a NaCl solution), the silver ions of the Cross-PA-Alg-MA-Ag will form a precipitate, leaving behind the Cross-PA-Alg-MA sodium salt, which can swell up more than the original silver salt.

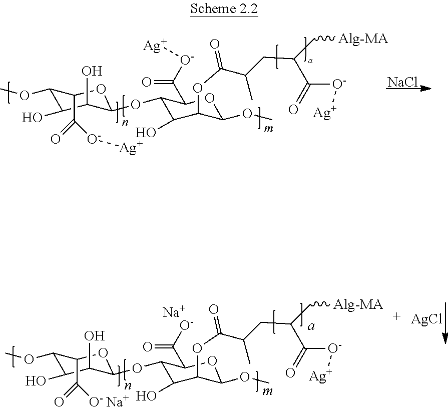

### Example 3: Examples of Cementitious Compositions According to the Invention

Portland cement CEM|52.5 N (PC), a commercial calcium sulfoaluminate (CSA) cement (i.tech ALI CEM Green®) and silica fume (SF) (Elkem Microsilica 940 U) were used in this example as binders. The ternary combination of PC (85 wt %), CSA (10 wt %) and SF (5 wt %) was mixed with sand and water to prepare repair mortars (RMs). The chemical composition of the binders is given in Table 1.

TABLE 1
Chemical composition of the binders

| | Quantity (mass %) | | |
|---|---|---|---|
| Oxide | PC | CSA | SF |
| CaO | 64.3 | 41.5 | 0.3 |
| SiO₂ | 18.3 | 8.1 | 97.0 |
| Al₂O₃ | 5.2 | 23.2 | 0.7 |
| Fe₂O₃ | 4.0 | 1.0 | 0.1 |
| Na₂O | 0.3 | 0.9 | 0.3 |
| MgO | 1.4 | 3.2 | 0.4 |
| SO₃ | 3.5 | 18.4 | 0.1 |
| LOI | 1.4 | 1.4 | — |

Cross-Alg-MA-Ag (see example 1) or Cross-PA-Alg-MA-Ag (see example 2) was added to the binder composition in either 0.32 wt % and 0.45 wt %, compared to the weight of the binder.

The sand/binder ratio and water/binder ratio were 2 and 0.5, respectively. CEN standard sand EN 196-1 with the grain size ranging between 0.08 and 2 mm was utilized. Samples were prepared by using a Hobart mixer, as follows: first solids were mixed for 30 s at a low speed of 140 rpm, then water was added and mixing continued at the same speed for 1 min. Afterwards, mixing was done manually by hand for 30 s. At last, materials were mixed at a high speed of 285 rpm for another 1 min.

Curing conditions of all samples were the same. All samples were demoulded 24 h after casting and were cured in a room with a curing room with 95% relative humidity and a temperature of 20° C. till the performance of the experiment.

### Example 4: Swelling Behaviour of Polymers of Example 1

FIG. 1 shows the swelling capacity of polymers of Example 1 and a comparative polymer (without silver), in the absence and in the presence of chloride ions.

FIG. 1 depicts the swelling capacity of the following solutions:
A: Cross-Alg-MA in Milli-Q® water
B: Cross-Alg-MA-Ag in Milli-Q® water
C: Cross-Alg-MA-Ag, contacted with a Milli-Q® water comprising chloride ions, in amount that 50% of the silver ions in the Cross-Alg-MA-Ag are precipitated as AgCl.
D: Cross-Alg-MA-Ag, contacted with a Milli-Q® water comprising chloride ions, in amount that 100% of the silver ions in the Cross-Alg-MA-Ag are precipitated as AgCl.

From FIG. 1 it can be concluded that in this example the presence of the silver ions in the Cross-Alg-MA-Ag polymer of the invention restricts the swelling capacity of the polymer as compared to Cross-Alg-MA (B vs A). In addition, and unexpectedly, the example shows that after reaction with chloride ions, and AgCl precipitation, the remaining Cross-Alg-MA-Ag polymers regain their swelling capacity (A vs D).

### Example 5: Swelling Behaviour of Polymers of Example 2

FIG. 2 shows the swelling capacity of polymers of Example 2 and a comparative polymer (without silver), in the absence and in the presence of chloride ions.

FIG. 2 depicts the swelling capacity of the following solutions:
A: Cross-PA-Alg-MA in Milli-Q® water
B: Cross-PA-Alg-MA-Ag in Milli-Q® water
C: Cross-PA-Alg-MA-Ag, contacted with a Milli-Q® water comprising chloride ions, in amount that 50% of the silver ions in the Cross-Alg-MA-Ag are precipitated as AgCl.
D: Cross-PA-Alg-MA-Ag, contacted with a Milli-Q® water comprising chloride ions, in amount that 100% of the silver ions in the Cross-Alg-MA-Ag are precipitated as AgCl.

From FIG. 2 it can be concluded that that in this example the presence of the silver ions in the Cross-PA-Alg-MA-Ag restricts the swelling capacity compared to Cross-PA-Alg-MA (A vs B) in this example. However, upon reaction with chloride ions, and AgCl precipitation, the remaining Cross-PA-Alg-MA regains at least part of its swelling capacity (A vs D).

### Example 6: Cl⁻ Ions Profiles in Concrete Samples

FIG. 3 depicts the free Cl ions profiles in concrete samples for different depths from the exposure surface, after the surface has been exposed to a 60 g/l NaCl solution for 7 weeks. The data shown in the dotted line and triangular datapoints is the control sample, where no covalently crosslinked polymer is incorporated in the concrete sample. The data shown in the dashed line and square data points is the sample comprising 0.27 wt % Cross-Alg-MA (with no silver). The data shown in the solid line and round data point, is an embodiment of the invention, wherein the sample comprises 0.45 wt % Cross-Alg-MA-Ag (see Example 1). The data shown in the dot-dash line and diamond data point, is an embodiment of the invention, wherein the sample comprises 0.32 wt % Cross-Alg-MA-Ag.

Although the embodiments according to the invention, may show a higher chloride content in the first few millimetres, compared to the control sample, the amount of chloride is drastically reduced at deeper depths, (from 4 mm onwards) which is proof of a reduced chloride diffusion coefficient due to increased chloride binding.

### Example 7: Concentration of Cl⁻ Ions in the Extracted Cement Pore Solution

FIG. 4 depicts the concentration of Cl ions in the extracted cement pore solution premixed with 1 wt % NaCl, see round data points (•) in FIG. 4. As shown, the addition of Cross-Alg-MA-Ag (see Example 1) by 0.02 g to the pore solution can bind some of the Cl⁻ ions. The Cl⁻ content was reduced by 58% after the addition of Cross-Alg-MA-Ag, see diamond data points (♦) in FIG. 4.

For the data shown in FIG. 4, two samples were prepared with Portland cement (without any alginates) and premixed with 1 wt % NaCl by the mass of cement. These samples have the w/c ratio of 0.5. Samples were cast in plastic cups (vol. 100 ml) and underwent the pore expression test 16 days after the production day. Plastic cups were kept in a room with the relative humidity of 60% and temperature of 20° C. The extracted pore solution was collected by a syringe and subsequently 1 ml of the collected pore solution was diluted with 10 ml of deionized water. Afterwards, 1 ml of the diluted solution was used for the titration test to measure the Cl⁻ content. To this end, a titration device (862 Compact Titrosampler) was used. The titration solution was AgNO₃ with a concentration of 0.01 mol/l. The diluted pore solution (9 ml) was mixed with 0.02 g Cross-Alg-MA-Ag and filtered after 1 h. The filtered solution was analysed again by the titration device.

The filtered Alg-MA-Ag obtained above, was washed with deionized water, oven dried at 40° C. and prepared for SEM-EDX analysis. FIG. 5 shows the SEM-EDX images of the cross-Alg-MA-Ag. FIG. 5b represents a magnification of the area indicated by the dashed line in FIG. 5a. As it is shown, a good distribution of bound Cl⁻ to the Alg-MA-Ag is observed. Moreover, the formation of flower-shaped crystals is evident from the SEM images. These crystals are very rich in Ag⁺.

### Example 8: Total Shrinkage of Mortar Samples

FIG. 6 depicts the total shrinkage of mortar samples. The circular data points are the control sample, wherein no crosslinked polymer is embedded. The solid diamond data points are a sample comprising the same composition as the control sample apart form 0.4 wt % Cross-PA-Alg-MA (no silver) that is added. The empty diamond data points are a sample comprising the same composition as the control sample apart form 0.8 wt % Cross-PA-Alg-MA (no silver) that is added. It may be observed that these three samples display about the same amount of total shrinkage.

The solid square data points are a sample according to an embodiment of the invention, wherein the sample comprises the same composition as the control sample apart form 0.4 wt % Cross-PA-Alg-MA-Ag. The empty square data points are a sample according to an embodiment of the invention, wherein the sample comprises the same composition as the control sample apart form 0.8 wt % Cross-PA-Alg-MA-Ag.

The data in FIG. 6 show that the total shrinkage of embodiments according to the invention is less compared to the control sample.

### Example 9: Exposure of Mortar Sample to NaCl Solution

Differences can be seen in CT-scan images of mortar samples with Cross-PA-Alg-MA-Ag (see Example 2) before and after exposure to NaCl solution. The Cross-PA-Alg-MA-Ag polymer particles possess a brighter colour before the exposure which is because of the presence of a heavy element such as Ag⁺ in the polymers. However, after exposure to the NaCl solution this brightness disappears due to the reaction between the Ag⁺ and the Cl ions. In addition, an increase in the size of the polymers after exposure to NaCl solution can be observed. This indicates the reswelling ability of the polymers by the exposure to a NaCl solution.

### Example 10: Autogenous Shrinkage of Mortar Samples

FIG. 7 depicts the autogenous shrinkage of mortar samples. The mortar samples were prepared:
A: comprising no polymers (solid lines);
B: comprising 0.66 wt % Cross-PA-Alg-MA-Ag (See Example 2), and comprising extra water to compensate for the water absorbed by the Cross-PA-Alg-MA-Ag (dotted lines); and
C: comprising 0.80 wt % of Cross-PA-Alg-MA-Ag (See Example 2) and comprising extra water to compensate for the water absorbed by the Cross-PA-Alg-MA-Ag (dot-dash lines),

wherein the wt % are expressed compared to the weight of the cementitious material in the mortar samples.

Experiments were prepared in two-fold (hence two lines for A, two lines for B and two lines for C in FIG. 7) to provide an idea of the deviation on the results.

Mortars were cast in corrugated tubes with a nominal length of 425±5 mm and a diameter of 29±0.5 mm to evaluate the autogenous shrinkage of specimens. The deformation was measured automatically every 30 seconds for 7 days with linear variable differential transducers (LVDT) with a range of 5 mm. An LVDT can convert the rectilinear motion of an object to which it is attached into a corresponding electrical signal. Experiments were performed in a room with the temperature of 20° C. and relative humidity of 60%.

Compared to the control experiment (A) which provides a negative value for autogenous shrinkage (representing actual shrinkage, which can lead to shrinkage cracking), Experiments (B) and (C) according to the invention provide a positive value for autogenous shrinkage (representing expansion, and thus avoiding shrinkage cracking), which can even be tuned by the amount of silver containing, covalently crosslinked polymer in the mortar samples, see Experiment (B) vs Experiment (C), which only differ from each other in the amount of silver containing, covalently crosslinked polymer.

### Example 11: Swelling Capacity of Cross-Alg-MA-Ag Vs Amounts of Silver Ions

FIG. 8 depicts the swelling capacity of the Cross-Alg-MA-Ag as prepared in Example 1, however comprising different amounts of silver ions. The variation of silver ions concentration is the result of differently concentrated AgNO₃ solutions in step 3 of the synthesis set out in Example 1. A data point is obtained for using Milli-Q® water, a 0.005 M, 0.01 M, 0.02 M, 0.05 M, 0.10 M, 0.20 M and 0.50 M AgNO₃ solutions.

### Example 12: Swelling Capacity of Cross-PA-Alg-MA-Ag Vs Amounts of Silver Ions

FIG. 9 depicts the swelling capacity of the Cross-PA-Alg-MA-Ag as prepared in Example 2, however comprising different amounts of silver ions. The variation of silver ions concentration is the result of differently concentrated AgNO₃ solutions in step 2 of the synthesis set out in Example 2. A data point is obtained for using Milli-Q® water, a 0.005 M, 0.01 M, 0.02 M, 0.05 M, 0.10 M, 0.20 M and 0.50 M AgNO₃ solutions.

1. A cementitious composition, preferably a concrete composition, a repair mortar, a repair paste, or a concrete coating composition, and wherein said cementitious composition comprises
one or more cementitious material(s); preferably wherein said one or more cementitious material(s) is (are) selected from the group comprising cement, fly ash, ground granulated slag, limestone, latent hydraulic materials, pozzolanic materials, geopolymers and alkali activated materials, or any combination thereof; and,
a silver-containing crosslinked polymer, wherein the crosslinked polymer is a covalently crosslinked polymer, and preferably wherein said silver-containing, crosslinked polymer comprises -A^{⊖}Ag^{⊕} groups; wherein A^{⊖} is an anion, preferably a carboxylate anion (—COO^{⊖}) or a sulphonate anion (—SO₃^{⊖}), and
optionally, an aggregate;
wherein the silver-containing, covalently crosslinked polymer comprises at least 2.0 weight % of silver ions, with wt % expressed as compared to the total weight of the (dry) silver-containing crosslinked polymer.

2. The cementitious composition according to claim 1, wherein said crosslinked polymer is obtained by crosslinking polymer chains of a polymer that comprises vinyl groups and/or (meth)acrylate groups, preferably (meth)acrylate groups.

3. The cementitious composition according to claim 1, wherein said crosslinked polymer is obtained by crosslinking polymer chains of a polymer in the presence of additional reactive monomer, preferably wherein said reactive monomer is selected from the group comprising (meth)acrylic acid, (meth)acrylamide, 2-(di(m)ethylamino)ethyl (meth)acrylate, N-[3-(dimethylamino) propyl]methacrylamide, and 2-Acrylamido-2-methyl-1-propanesulfonic acid.

4. The cementitious composition according to claim 1, wherein the cementitious composition comprises at least 0.10 weight % to at most 5.00 weight %, with wt % based on the total weight of the cementitious composition, of said silver-containing, covalently crosslinked polymer.

5. The cementitious composition according to claim 1, wherein the silver-containing, covalently crosslinked polymer comprises at most 30.0 weight % of silver ions, with wt % expressed as compared to the total weight of the (dry) silver-containing crosslinked polymer.

6. The cementitious composition according to claim 1, wherein the polymer that is crosslinked is a hydrophilic polymer.

7. The cementitious composition according to claim 1, wherein the swelling capacity (g/g) of the crosslinked polymer without the silver ions is at least 10.0, measured as described in the specification, preferably in deionised water.

8. The cementitious composition according to claim 1, wherein the polymer that is crosslinked is a polyol, a polyamine or a polyacid, preferably a polyacid.

9. The cementitious composition according to claim 1, wherein the polymer that is crosslinked is a polysaccharide or a salt derivative thereof, preferably a polysaccharide comprising sugar moieties wherein the sugar moieties comprise an acid functionality or a salt derivative thereof, preferably an alkali metal salt derivative thereof, more preferably an alginate or a salt derivative thereof, preferably an alkali metal salt derivative thereof.

10. The cementitious composition according to claim 1, wherein the polymer that is crosslinked is a synthetic polymer having anionic groups, preferably carboxylate anion (—COO^{⊖}) or a sulphonate anion (—SO₃^{⊖}) groups, and preferably is poly(aspartic acid) or a salt derivative thereof, preferably an alkali metal salt derivative thereof.

11. A method for making a cementitious composition comprising the step of:
a) preparing a cementitious composition by mixing a silver-containing crosslinked polymer as defined in claim 1, and one or more cementitious material(s), as defined in claim 1; and optionally aggregate(s).

12. The method according to claim 11, further comprising the step of: b) further admixing said cementitious composition with a suitable amount of water, optionally comprising an alkali activator, thereby obtaining a workable and curable cementitious composition.

13. A method for preparing a concrete material having reduced shrinkage and/or showing reduced chloride ion diffusion and/or ingress, comprising the step of preparing said concrete material with a cementitious composition according to claim 1.

14. A method for repairing damaged areas in a concrete structure, said method comprising the step of filling and/or treating said damaged areas with a cementitious composition according to claim 1.

15. An admixture for a cementitious composition, wherein the admixture comprises the silver-containing, crosslinked polymer as defined in claim 1.

16. The admixture according to claim 15, wherein the cementitious composition is a concrete composition or a repair mortar or a repair paste or a concrete coating composition.

17. The admixture according to claim 15, wherein the admixture is a shrinkage reducing agent and/or a chloride binding agent.

18. A method for preparing a concrete material having reduced shrinkage and/or showing reduced chloride ion diffusion and/or ingress, comprising the step of preparing said concrete material with a cementitious composition prepared according to claim 11.

19. A method for repairing damaged areas in a concrete structure, said method comprising the step of filling and/or treating said damaged areas with a cementitious composition prepared according to claim 11.
